(19) United States
(12) Patent Application Publication
(10) Pub. No.: US 2023/0278915 A1
(43) Pub. Date: Sep. 7, 2023

(54) CHEMICALLY STRENGTHENED GLASS AND METHOD FOR MANUFACTURING THE SAME

(71) Applicant: AGC Inc., Tokyo (JP)

(72) Inventors: Yusuke FUJIWARA, Tokyo (JP); Akio SHIZUKAI, Tokyo (JP)

(73) Assignee: AGC Inc., Tokyo (JP)

(21) Appl. No.: 18/178,583

(22) Filed: Mar. 6, 2023

(30) Foreign Application Priority Data
Mar. 7, 2022 (JP) 2022-034686
Oct. 17, 2022 (JP) 2022-166402

(51) Int. Cl. C03C 21/00; C03C 3/087

(52) U.S. Cl. CPC C03C 21/002; C03C 3/087

(57) ABSTRACT

The present invention relates to a chemically strengthened glass, having a slope of a K₂O concentration of −1.9%/μm or more at a depth of 1 to 3 μm and −0.001%/μm or less at a depth of 5 to 10 μm, in a K₂O concentration profile having an abscissa representing the depth (μm) from a surface of the glass and an ordinate representing the K₂O concentration (%) by mole percentage in terms of oxides.

### CROSS-REFERENCE TO RELATED APPLICATIONS

This application claims priority from Japanese Patent Application No. 2022-034686 filed on Mar. 7, 2022, and Japanese Patent Application No. 2022-166402 filed on Oct. 17, 2022, the entire subject matter of which is incorporated herein by reference.

### TECHNICAL FIELD

The present invention relates to a chemically strengthened glass and a method for manufacturing the chemically strengthened glass.

### BACKGROUND ART

Cover glasses and the like for use in the displays of various information terminal devices have hitherto been required to have excellent strength, and a chemically strengthened glass is used because the glass has high crack resistance even in thin types thereof. A chemically strengthened glass is produced by an ion exchange treatment in which a glass is brought into contact with a molten-salt composition including sodium nitrate, potassium nitrate, etc. to thereby form a compressive stress layer in surface portions of the glass.

In the ion exchange treatment, an ion exchange occurs between alkali metal ions contained in the glass and alkali metal ions having a different ionic radius contained in the molten-salt composition to form a compressive stress layer in surface portions of the glass. The strength of the chemically strengthened glass depends on a stress profile expressed by compressive stress (hereinafter also abbreviated as CS) using a depth from a glass surface as a variable.

There are cases where the cover glasses of portable terminals or the like crack due to a deformation caused by dropping, etc. For preventing such breakage, i.e., breakage due to bending, it is effective to heighten the compressive stress of the glass surfaces. Because of this, surface compressive stresses as high as 700 MPa or above are frequently imparted nowadays.

There are also cases where the cover glasses of portable terminals may crack upon a collision against a projection when the terminals drop onto asphalt or sand. For preventing such breakage, i.e., breakage due to impact, it is effective to increase the depth of a compressive stress layer, to form a compressive stress layer extending to deeper portions of the glass, and to thereby improve the strength.

Meanwhile, in the case where a compressive stress layer is formed in surface portions of a glass article, tensile stress (hereinafter also abbreviated as CT) according to the total surface compressive stress occurs inevitably in a center in a thickness direction (hereinafter also abbreviated as center portion) of the glass article. In the case where the value of CT is too large, this glass article shatters when breaking and scatters the fragments. In the case where the CT value exceeds a threshold thereof (hereinafter also abbreviated as CT limit), the glass can destroy itself when damaged, resulting in a tremendously increased number of fragments. Each glass composition has an intrinsic value of the CT limit.

Consequently, a chemically strengthened glass is required to have further improved strength imparted by heightening the surface compressive stress and forming a compressive stress layer extending to deeper portions, while a total surface-layer compressive stress is designed so that the CT does not exceed the CT limit.

Meanwhile, in steps for producing a chemically strengthened glass, there are cases where chemically strengthened glasses which do not satisfy a desired specification, e.g., ones having defects on a level below a standard or ones having an inappropriate stress profile, may be yielded. Hitherto, as a method for reprocessing such a chemically strengthened glass which has the defects or the inappropriate stress profile after an ion exchange, the following method is employed: a compressive stress layer of a chemically strengthened glass is removed by an ion exchange for reducing a compressive stress of the compressive stress layer (hereinafter also abbreviated as reverse ion exchange), by polishing or the like, and then an ion exchange (hereinafter also abbreviated as re-ion exchange) is performed again to thereby form a compressive stress layer.

For example, Patent Document 1 discloses a method for manufacturing a chemically strengthened glass, including the following steps in the following order: a glass sheet preparation step (1), in which a glass sheet having a compressive stress layer in a surface layer is prepared; a first ion exchange step (2), in which at least one ion-exchange set is performed so that the glass sheet is brought into contact with an inorganic-salt composition to reduce the compressive stress of the compressive stress layer; and a second ion exchange step (3), in which at least one ion-exchange set is performed so that the glass sheet is brought into contact with an inorganic-salt composition to increase the compressive stress of the compressive stress layer in the surface layer.

Patent Document 2 discloses a method including: a step in which a glass article that has undergone ion exchange is subjected to a reverse ion exchange in a reverse ion exchange bath containing a lithium salt to produce a glass article that has undergone the reverse ion exchange; and a step in which the glass article that has undergone the reverse ion exchange is subjected to re-ion exchange in a re-ion exchange bath to form a glass article that has undergone the re-ion exchange.

Patent Document 3 discloses a method including a step in which a glass article that has undergone an ion exchange is subjected to a reverse ion exchange with a reverse ion exchange medium to yield a glass article that has undergone the reverse ion exchange, in which the reverse ion exchange medium contains a lithium salt and a non-ion exchangeable polyvalent-metal salt.
Patent Document 1: JP2019-194143A
Patent Document 2: JP2020-506151A
Patent Document 3: JP2021-525208A

### SUMMARY OF INVENTION

An object of the present invention is to provide a chemically strengthened glass showing excellent strength and a method for manufacturing the chemically strengthened glass.

The present inventors have discovered that a chemically strengthened glass having a specific K₂O concentration profile and showing excellent strength is obtained by subjecting a lithium-containing glass having a compressive stress layer formed in surface layers thereof by chemical strengthening at least including an ion exchange with K ions to a reverse ion exchange under specific conditions, subsequently removing a surface of the glass, and performing a re-ion exchange. The invention has been thus completed.

The invention relates to a chemically strengthened glass, having a slope (%/μm) of a K₂O concentration at a depth of 1 to 3 μm of −1.9 or more and a slope (%/μm) of a K₂O concentration at a depth of 5 to 10 μm of −0.001 or less, in a K₂O concentration profile having an abscissa representing the depth (μm) from a surface of the glass and an ordinate representing the K₂O concentration (%) by mole percentage in terms of oxides.

The invention further relates to a method for manufacturing a chemically strengthened glass, including the following successive steps (1) to (3):
(1) subjecting a lithium-containing glass to an ion exchange at least once with a first inorganic-salt composition containing potassium;
(2) keeping the lithium-containing glass in contact with a second inorganic-salt composition including LiNO₃ and NaNO₃ and having a mass ratio of NaNO₃ to LiNO₃ of 0.25 to 3.0, at 425° C. or higher for 5 hours or longer to perform a reverse ion exchange; and
(3) subjecting the lithium-containing glass to an ion exchange at least once with a third inorganic-salt composition containing potassium.

The invention furthermore relates to a chemically strengthened glass, having a slope (%/μm) of a K₂O concentration at a depth of 1 to 3 μm of −1.9 or more and 0.0 or less and a slope (%/μm) of a K₂O concentration at a depth of 5 to 10 μm of −0.001 or less, in a K₂O concentration profile having an abscissa representing the depth (μm) from a surface of the glass and an ordinate representing the K₂O concentration (%) by mole percentage in terms of oxides.

The chemically strengthened glass of the invention has a specific K₂O concentration profile and has a surface layer introduced by a large amount of K ions. Because of this, the chemically strengthened glass has excellent surface strength and can have enhanced falling ball strength and enhanced scratch resistance.

By the method for manufacturing the chemically strengthened glass of the invention, the chemically strengthened glass having the specific K₂O concentration profile and showing excellent strength is obtained by subjecting the lithium-containing glass having a compressive stress layer formed in the surface layers thereof by the chemical strengthening at least including the ion exchange with K ions to the reverse ion exchange under specific conditions, subsequently removing the surface of the glass, and performing the re-ion exchange.

### BRIEF DESCRIPTION OF DRAWINGS

Each of FIG. 1A and FIG. 1B shows stress profiles of a chemically strengthened glass in an embodiment of the present invention. FIG. 1A shows stress profiles of surface layer portions. FIG. 1B shows stress profiles of deep layer portions.

Each of FIG. 2A and FIG. 2B shows a result of an examination of a chemically strengthened glass for Na₂O concentrations with an EPMA (Example 1). Each of FIG. 2C and

FIG. 2D shows a result of an examination of a chemically strengthened glass for K₂O concentrations with the EPMA (Example 1). In each of FIG. 2A to FIG. 2D, the abscissa indicates a depth (μm) from a surface of the glass and the ordinate indicates concentration (%) by mole percentage in terms of oxides.

Each of FIG. 3A and FIG. 3B shows a result of an examination of a chemically strengthened glass for Na₂O concentrations with an EPMA (Example 2). Each of FIG. 3C and FIG. 3D shows a result of an examination of a chemically strengthened glass for K₂O concentrations with the EPMA (Example 2). In each of FIG. 3A to FIG. 3D, the abscissa indicates a depth (μm) from the surface of the glass and the ordinate indicates concentration (%) by mole percentage in terms of oxides.

Each of FIG. 4A and FIG. 4B shows a result of an examination of a chemically strengthened glass for Na₂O concentrations with an EPMA (Example 5). Each of FIG. 4C and FIG. 4D shows a result of an examination of the chemically strengthened glass for K₂O concentrations with the EPMA (Example 5). In each of FIG. 4A to FIG. 4D, the abscissa indicates a depth (μm) from the surface of the glass and the ordinate indicates concentration (%) by mole percentage in terms of oxides.

### DESCRIPTION OF EMBODIMENTS

The invention is described in detail below, but the present invention is not limited to the following embodiments and can be modified at will when practiced, unless the modifications depart from the gist of the invention.

In this specification, the symbol “-” or the word “to” that is used to express a numerical range includes the numerical values before and after the symbol or the word as the upper limit and the lower limit of the range, respectively. Also, in the specification, unless otherwise specified, the composition (content of each component) of the glass is represented by molar percentage in terms of oxides.

In the following, the “chemically strengthened glass” refers to a glass after a chemical strengthening treatment, and the “glass for chemical strengthening” refers to a glass before the chemical strengthening treatment.

In the specification, unless otherwise specified, the glass composition is represented by mol % in terms of oxides, and mol % is simply denoted as “%”.

In this specification, the expression “substantially free of” means the content of a component is lower than or equal to an impurity level contained in raw materials and the like, that is, the component is not added thereto intentionally. Specifically, for example, the content is lower than 0.1%.

In this specification, the “K₂O concentration profile” or “Na₂O concentration profile” means a profile which shows a concentration distribution using the abscissa as a depth (μm) from a surface of the glass and the ordinate as a K₂O concentration (%) or a Na₂O concentration by mole percentage in terms of oxides.

In this specification, a K₂O concentration or a Na₂O concentration at a depth x (μm) is measured by examining the concentration at a cross-section in a sheet thickness direction with an EPMA (electron probe microanalyzer). The measurement with the EPMA is specifically conducted, for example, in the following manner.

First, a glass sample is embedded in an epoxy resin, and the embedded sample is mechanically polished along a plane perpendicular to a first main surface and a second main surface that faces the first main surface, thereby producing a cross-section sample. The cross-section obtained by the polishing is subjected to C-coat and examined with an EPMA (JXA-8500F, manufactured by JEOL Ltd.). An X-ray intensity line profile of K₂O or Na₂O is acquired at intervals of 1 μm under the conditions of an accelerating voltage of 15 kV, a probe current of 30 nA, and an integrated time of 1,000 msec./point. With respect to the K₂O concentration profile or Na₂O concentration profile obtained, an average count for [a center in a thickness direction (0.5×t)]±25 μm (the sheet thickness being taken as t μm) is regarded as a bulk composition and counts for the whole sheet thickness are proportionally converted to mol % to calculate K₂O or Na₂O concentrations.

In this specification, the “depth of a potassium-ion diffusion layer” means a depth at which the K₂O concentration comes into the range of +2σ or less, with respect to an average K₂O concentration (%) in [center in a thickness direction (0.5×t)]±25 μm and a dispersion a thereof in the K₂O concentration profile in a view from the outermost-surface side.

In this specification, the “stress profile” means a profile which shows compressive stress using a depth from a surface of the glass as a variable. In the stress profile, tensile stress is shown as negative compressive stress.

The “compressive stress (CS)” can be measured as follows: a cross-section surface of the glass is worked into thin pieces; and a sample subjected to the thin pieces is analyzed by a birefringence imaging system. A birefringence meter in the birefringence imaging system is a device for measuring the magnitude of retardation generated due to stress by using a polarizing microscope and a liquid crystal compensator, etc., and examples thereof include Birefringence Imaging System Abrio-IM manufactured by CRi, Inc.

In some cases, the compressive stress can also be measured utilizing scattered light photoelasticity. In this method, CS can be measured by causing light to be incident into the surface of the glass and analyzing polarization of scattered light. Examples of the stress meter utilizing scattered light photoelasticity include Scattered Light Photoelastic Stress Meter SLP-2000 manufactured by Orihara Manufacturing Co., Ltd.

In this specification, the “depth of a compressive stress (DOC)” is a depth (μm) of a compressive stress measured using the SLP-2000, and is a depth at which the compressive stress becomes zero. Hereinafter, surface compressive stress is often expressed by CS₀ and compressive stress at a depth of 50 μm from the surface is often expressed by CS₅₀. The “internal tensile stress (CT)” means tensile stress at a depth corresponding to ½ a sheet thickness t.

In this specification, the “4PB strength” (four-point bending strength) is measured by the following method.

Test pieces of 50 mm×50 mm are subjected to a four-point bending test under the conditions of a distance between outer fulcrums of 30 mm in a supporting tool, a distance between inner fulcrums of 10 mm therein, and a crosshead speed of 5.0 mm/min to thereby obtain a fracture stress (unit: MPa), which is taken as a four-point bending strength. The number of test pieces is, for example, 10.

<Stress Measurement Methods>

In recent years, a main type of glass for a cover glass of smartphones, etc. is obtained by conducting chemical strengthening by two steps of: exchanging lithium ions inside glass with sodium ions (Li—Na exchange); and thereafter, exchanging sodium ions inside the glass with potassium ions (Na—K exchange) in a surface layer portion of the glass.

For acquiring nondestructively the stress profile of such a two-step chemically strengthened glass, for example, Scattered Light Photoelastic Stress Measurement (hereinafter, sometimes simply referred as SLP) or glass surface stress meter (Film Stress Measurement; hereinafter, sometimes simply referred to as FSM) may be used in combination.

In the method using a scattered light photoelastic stress meter (SLP), a compressive stress derived from the Li—Na exchange can be measured in the inside of the glass at dozens of μm or more from a surface layer of the glass. On the other hand, in the method using a glass surface stress meter (FSM), a compressive stress derived from the Na—K exchange can be measured in the glass surface layer portion at dozens of μm or less from the surface of the glass (see, for example, WO2018/056121 and WO2017/115811). Accordingly, for the two-step chemically strengthened glass, a synthesized profile of SLP information and FSM information is sometimes used as a stress profile in the surface layer of the glass and the inside thereof.

In the invention, the stress profile measured by scattered light photoelastic stress meter (SLP) is mainly used. Incidentally, in the specification, in the case where compressive stress CS, tensile stress CT, depth of a compressive stress layer DOL, etc. are used, these indicate the values in the SLP stress profile.

The scattered light photoelastic stress meter is a stress measuring device including: a polarization phase difference-varying member for varying a polarization phase difference of a laser light by one wavelength or more with respect to a wavelength of the laser light; an imaging device for acquiring a plurality of images by imaging, at predetermined time intervals by a plurality of times, a scattered light generated when the laser light with the polarization phase difference being varied enters a strengthened glass; and a computing unit for measuring a periodic luminance change of the scattered light by using the plurality of images, computing a phase change in the luminance change, and based on the phase change, computing a stress distribution in a depth direction from a surface of the chemically strengthened glass.

A method for measuring a stress profile by using the scattered light photoelastic stress meter includes the method described in WO2018/056121. Examples of the scattered light photoelastic stress meter include SLP-1000 and SLP-2000 manufactured by Orihara Manufacturing Co., Ltd. An attached Software SlpIV_up3 (Ver. 2019.01.10.001) combined with these scattered light photoelastic stress meters enables a highly accurate stress measurement.

<Chemically Strengthened Glass>

The chemically strengthened glass according to this embodiment (hereinafter referred to also as “this chemically strengthened glass”) is characterized by having a slope (%/μm) of a K₂O concentration at a depth of 1 to 3 μm of −1.9 or more and a slope (%/μm) of a K₂O concentration at a depth of 5 to 10 μm of −0.001 or less, in a K₂O concentration profile having an abscissa representing the depth (μm) from a surface of the glass and an ordinate representing the K₂O concentration (%) by mole percentage in terms of oxides.

In the specification, a slope in the K₂O concentration profile is a slope of the K₂O concentration in the K₂O concentration profile.

In the case where the K₂O concentration profile has a slope (%/μm) a depth of 1 to 3 μm of −1.9 or more at and a slope (%/μm) at a depth of 5 to 10 μm of −0.001 or less, a surface layer portion can have heightened K ion concentration and improved strength. Examples of the strength include bending strength, surface hardness, falling ball strength, and scratch resistance.

In the case where the slope (%/μm) at a depth of 1 to 3 μm in the K₂O concentration profile is −1.9 or more, the surface layer portion can have heightened K ion concentration and improved strength. The slope (%/μm) at a depth of 1 to 3 μm in the K₂O concentration profile is preferably −1.80 or more, more preferably −1.70 or more, still more preferably −1.65 or more, especially preferably −1.60 or more.

The slope (%/μm) at a depth of 1 to 3 μm in the K₂O concentration profile is preferably −1.000 or less, more preferably −1.10 or less, still more preferably −1.20 or less, especially preferably −1.30 or less. In the case where the slope (%/μm) at a depth of 1 to 3 μm in the K₂O concentration profile is −1.000 or less, excess stress not contributing to the strength can be diminished. In the case where the slope (%/μm) at a depth of 1 to 3 μm in the K₂O concentration profile has a value of 0.0 or less, the surface layer portion functions.

In the case where the slope (%/μm) at a depth of 5 to 10 μm in the K₂O concentration profile is −0.001 or less, potassium ions in the surface layer of the glass are diffused throughout a microcrack region of the surface and this can improve the bending strength due to surface compressive stress. The slope (%/μm) at a depth of 5 to 10 μm in the K₂O concentration profile is preferably −0.010 or less, more preferably −0.020 or less, still more preferably −0.030 or less, especially preferably −0.040 or less.

The slope (%/μm) at a depth of 5 to 10 μm in the K₂O concentration profile is preferably −0.200 or more, more preferably −0.180 or more, still more preferably −0.160 or more, especially preferably −0.140 or more. In the case where the slope (%/μm) at a depth of 5 to 10 μm in the K₂O concentration profile is −0.200 or more, an amount of potassium ions in the surface layer of the glass is not too many and ion-exchange inhibition by restrengthening can be inhibited to improve the stress in a deep layer.

This chemically strengthened glass preferably has a slope (%/μm) of a Na₂O concentration at a depth of 10 to 50 μm of −0.001 or less and a slope (%/μm) of the Na₂O concentration at a depth of 50 to 90 μm of −0.012 or more, in a Na₂O concentration profile having an abscissa representing the depth (μm) from a surface of the glass and an ordinate representing the Na₂O concentration (%) by mole percentage in terms of oxides.

In the case where the Na₂O concentration profile has the slope (%/μm) of −0.001 or less at a depth of 10 to 50 μm and the slope (%/μm) of −0.012 or more at a depth of 50 to 90 μm, this chemically strengthened glass can have lower Na ion concentrations in the surface layer portion than conventional chemically strengthened glasses and the generation of excess stress not contributing to the strength can be more effectively reduced.

In the specification, a slope in the Na₂O concentration profile is a slope of the Na₂O concentration in the Na₂O concentration profile.

The slope (%/μm) at a depth of 10 to 50 μm in the Na₂O concentration profile is preferably −0.001 or less, more preferably −0.002 or less, still more preferably −0.003 or less, especially preferably −0.004 or less. In the case where the slope (%/μm) at a depth of 10 to 50 μm in the Na₂O concentration profile is −0.001 or less, this chemically strengthened glass can have lower Na ion concentrations in the surface layer portion than conventional chemically strengthened glasses and the generation of excess stress not contributing to the strength can be more effectively reduced.

The slope (%/μm) at a depth of 10 to 50 μm in the Na₂O concentration profile is preferably −0.020 or more, more preferably −0.018 or more, still more preferably −0.016 or more, especially preferably −0.014 or more. In the case where the slope (%/μm) at a depth of 10 to 50 μm in the Na₂O concentration profile is −0.020 or more, this chemically strengthened glass can have lower Na ion concentrations in the surface layer portion than conventional chemically strengthened glasses and the generation of excess stress not contributing to the strength can be more effectively reduced.

The slope (%/μm) at a depth of 50 to 90 μm in the Na₂O concentration profile is preferably −0.012 or more, more preferably −0.011 or more, still more preferably −0.010 or more, especially preferably −0.009 or more. In the case where the slope (%/μm) at a depth of 50 to 90 μm in the Na₂O concentration profile is −0.012 or more, a deep layer portion can have heightened Na ion concentrations and stress contributing to falling strength can be generated.

The slope (%/μm) at a depth of 50 to 90 μm in the Na₂O concentration profile is preferably −0.002 or less, more preferably −0.003 or less, still more preferably −0.004 or less, especially preferably −0.005 or less. In the case where the slope (%/μm) at a depth of 50 to 90 μm in the Na₂O concentration profile is −0.002 or less, the deep layer portion can have heightened Na ion concentrations and stress contributing to falling strength can be generated.

The chemically strengthened glass according to this embodiment preferably satisfies that in the K₂O concentration profile, the absolute value of a value obtained by dividing the slope (%/μm) at a depth of 5 to 10 μm by the slope (%/μm) at a depth of 1 to 3 μm is 0.005 to 0.10. In the case where the absolute value is within the range, potassium ions in the surface layer of the glass can be diffused throughout the microcrack region of the surface. The absolute value is more preferably 0.010 or more, still more preferably 0.015 or more, especially preferably 0.020 or more. The absolute value is more preferably 0.095 or less, still more preferably 0.090 or less, yet still more preferably 0.085 or less, especially preferably 0.080 or less.

The chemically strengthened glass according to this embodiment preferably satisfies that in the Na₂O concentration profile, the absolute value of a value obtained by dividing the slope (%/μm) at a depth of 50 to 90 μm by the slope (%/μm) at a depth of 10 to 50 μm is 0.50 to 4.0. The absolute value is more preferably 0.60 or more, still mora preferably 0.70 or more, yet still more preferably 0.80 or more, especially preferably 0.90 or more. The absolute value is more preferably 3.9 or less, still more preferably 3.8 or less, yet still more preferably 3.7 or less, especially preferably 3.6 or less.

In the K₂O concentration profile of the chemically strengthened glass according to this embodiment, the absolute value of a difference between a K₂O concentration (%) at a depth of 15 to 25 μm and a K₂O concentration (%) in a center portion is preferably 0.20% or less, more preferably 0.16% or less, still more preferably 0.12% or less, especially preferably 0.10% or less. In the case where the absolute value of the difference between the K₂O concentration (%) at a depth of 15 to 25 μm and the K₂O concentration (%) in the center portion is 0.20% or less, the tensile stress balanced with the compressive stress is diminished and scratches due to tensile stress can be inhibited from growing. The term “K₂O concentration at a depth of 15 to 25 μm” means an average of K₂O concentrations at a depth of 15 to 25 μm. A lower limit of the absolute value of the difference is usually preferably 0.001% or more, more preferably 0.005% or more.

The chemically strengthened glass according to this embodiment includes a potassium-ion diffusion layer having a depth of 5 μm or more, more preferably 7 μm or more. Meanwhile, the depth thereof is usually preferably 20 μm or less, more preferably 18 μm or less, still more preferably 16 μm or less. In the case where the potassium-ion diffusion layer has a depth of 5 μm or more, the surface layer portion can have increased K ion concentrations to attain improved strength.

Stress profiles of one embodiment of this chemically strengthened glass are shown in FIG. 1A and FIG. 1B. FIG. 1A shows a stress profile of a surface layer portion. FIG. 1B shows a stress profile of a deep layer portion. In FIG. 1A and FIG. 1B, the continuous lines show an Inventive Example and the dotted lines show a Comparative Example. This chemically strengthened glass has higher K-ion-dependent compressive stress in the surface layer portion than the Comparative Example as shown in FIG. 1A and is equal to the Comparative Example in compressive stress and DOC in the deep layer portion as shown in FIG. 1B. Because of this, this chemically strengthened glass has excellent strength. The stress profile of the surface layer portion indicates a depth (μm) of a compressive stress layer measured using the FSM. The stress profile of the deep layer portion indicates a depth (μm) of a compressive stress measured using the SLP-2000.

This chemically strengthened glass preferably has a surface compressive stress (CS₀) of 500 MPa or more, because this renders the chemically strengthened glass less apt to break when deformed, e.g., deflected. The CS₀ is more preferably 600 MPa or more, still more preferably 700 MPa or more. The more the CS₀, the higher the strength. However, too large values of the CS₀ may cause the chemically strengthened glass to shatter when breaking, thus the CS₀ is preferably 1,200 MPa or less, more preferably 1,000 MPa or less.

The chemically strengthened glass preferably has a compressive stress at a depth of 50 μm from the surface (CS₅₀) of 50 MPa or more, because when portable terminals and the like equipped with this chemically strengthened glass as the cover glasses are dropped, this chemically strengthened glass is apt to be prevented from breaking. The CS₅₀ is more preferably 60 MPa or more, still more preferably 70 MPa or more. The more the CS₅₀, the higher the strength. However, too more values of the CS₅₀ may cause the chemically strengthened glass to shatter when breaking, thus the CS₅₀ is preferably 180 MPa or less, still more preferably 160 MPa or less.

The chemically strengthened glass preferably has a compressive stress at a depth of 90 μm from the surface (CS₉₀) of 30 MPa or more, because when portable terminals and the like equipped with this chemically strengthened glass as the cover glasses are dropped onto coarse sand, etc., this chemically strengthened glass is prevented from breaking. The CS₉₀ is more preferably 40 MPa or more, still more preferably 50 MPa or more. The more the CS₉₀, the higher the strength. However, too more values of the CS₉₀ may cause the chemically strengthened glass to shatter when breaking, thus the CS₉₀ is preferably 170 MPa or less, still more preferably 150 MPa or less.

This chemically strengthened glass preferably has a DOC of 80 μm or more because this makes the glass less apt to break even when a surface of the glass is scratched. The DOC is more preferably 90 μm or more, still more preferably 100 μm or more, especially preferably 110 μm or more. The more the DOC, the less the glass is apt to break even when a surface of the glass is scratched. However, in chemically strengthened glasses, tensile stress generates in an inner portion in accordance with compressive stress formed near the surface and, hence, the DOC cannot be excessively increased. In the case where the thickness is represented by t, the DOC is preferably t/4 or less, more preferably t/5 or less. From the viewpoint of shortening the time period necessary for the chemical strengthening, the DOC is preferably 160 μm or less, more preferably 150 μm or less.

The CS and DOC of the chemically strengthened glass can be suitably regulated by regulating conditions for the chemical strengthening, the composition and thickness of the glass, etc.

This chemically strengthened glass contains a large amount of K ions introduced into surface layers of the glass and hence shows excellent strength. This chemically strengthened glass has a four-point bending strength of preferably 480 MPa or more, more preferably 500 MPa or more, still more preferably 520 MPa or more, most preferably 540 MPa or more. In the case where the four-point bending strength thereof is 480 MPa or more, an improvement in strength reliability can be attained.

This chemically strengthened glass is typically a sheet-like glass article and may have a flat-sheet shape or a curved shape. This chemically strengthened glass may include portions differing in thickness.

In the case where this chemically strengthened glass has a sheet shape, the thickness (t) thereof is preferably 3,000 μm or less and is more preferably 2,000 μm or less, 1,600 μm or less, 1,500 μm or less, 1,100 μm or less, 900 μm or less, 800 μm or less, and 700 μm or less, in order of increasing preference. From the viewpoint of obtaining sufficient strength through a chemical strengthening treatment, the thickness (t) thereof is preferably 300 μm or more, more preferably 400 μm or more, still more preferably 500 μm or more.

«Uses»

This chemically strengthened glass is useful as cover glasses for use in electronic appliances including mobile devices such as portable phones and smartphones. This chemically strengthened glass is useful also as the cover glasses of electronic appliances not intended to be portable, such as TVs, personal computers, and touch panels, and as elevator wall surfaces and wall surfaces of houses, buildings, or the like (full-wall displays). Furthermore, this chemically strengthened glass is useful as building materials, e.g., window glasses, table tops, interior trims and other parts for motor vehicles, airplanes, etc., and cover glasses for these, and useful for housings having a curved shape, etc.

«Composition»

In this specification, the “base composition of a chemically strengthened glass” is a glass composition of a glass for chemical strengthening. A glass composition of a portion deeper than a depth of a compressive stress layer of a chemically strengthened glass is approximately equal to a base composition of a chemically strengthened glass, except for the case where an extreme ion exchange treatment is given thereto.

The chemically strengthened glass according to this embodiment preferably has a base composition including, by mole percentage in terms of oxides,

52 to 75% of SiO₂,

8 to 20% of Al₂O₃, and

5 to 18% of Li₂O.

More preferably, the chemically strengthened glass according to this embodiment has a base composition including, by mole percentage in terms of oxides,

52 to 75% of SiO₂,

8 to 20% of Al₂O₃,

5 to 18% of Li₂O,

0 to 15% of Na₂O,

0 to 5% of K₂O,

0 to 20% of MgO,

0 to 20% of CaO,

0 to 20% of SrO,

0 to 20% of BaO,

0 to 10% of ZnO,

0 to 1% of TiO₂,

0 to 8% of ZrO₂, and

0 to 5% of Y₂O₃.

Preferred base compositions of the glass are explained below.

In the chemically strengthened glass according to this embodiment, SiO₂ is a component which forms a network structure of the glass, and is a component which enhances the chemical durability. The content of SiO₂ is preferably 52% or more, more preferably 56% or more, still more preferably 60% or more, especially preferably 64% or more. Meanwhile, from the viewpoint of improving the meltability, the content of SiO₂ is preferably 75% or less, more preferably 73% or less, still more preferably 71% or less, especially preferably 69% or less.

Al₂O₃ is a component which enables higher surface compressive stress to be imparted by chemical strengthening, and is essential. The content of Al₂O₃ is preferably 8% or more, more preferably 10% or more, still more preferably 11% or more, especially preferably 12% or more. Meanwhile, from the viewpoint of preventing the glass from having too high a devitrification temperature, the content of Al₂O₃ is preferably 20% or less, more preferably 18% or less, still more preferably 17% or less, yet still more preferably 16% or less, most preferably 15% or less.

Li₂O is a component which causes surface compressive stress to be formed by ion exchange. The content of Li₂O is preferably 5% or more, more preferably 7% or more, still more preferably 9% or more, especially preferably 11% or more. Meanwhile, from the viewpoint of making the glass stable, the content of Li₂O is preferably 18% or less, more preferably 17% or less, still more preferably 16% or less, most preferably 15% or less.

MgO is a component which stabilizes the glass and is also a component which enhances the mechanical strength and chemical resistance. It is hence preferable that MgO be contained, for example, in the case where the content of Al₂O₃ is relatively low. The content of MgO is preferably 1% or more, more preferably 2% or more, still more preferably 3% or more, especially preferably 4% or more. Meanwhile, in the case where MgO is added too much, viscosity of the glass is reduced and the glass is prone to suffer devitrification or phase separation. The content of MgO is preferably 20% or less, more preferably 19% or less, still more preferably 18% or less, especially preferably 17% or less.

CaO, SrO, BaO, and ZnO are each a component which improves the meltability of the glass, and may be contained.

CaO is a component which improves the meltability of the glass and is also a component which improves the crushability of the chemically strengthened glass, and may be contained. The content of CaO, when it is contained, is preferably 0.5% or more, more preferably 1% or more, still more preferably 2% or more, especially preferably 3% or more, most preferably 5% or more. Meanwhile, the content of CaO is preferably 20% or less because CaO contents exceeding 20% result in a considerable decrease in ion-exchange performance. The content of CaO is more preferably 16% or less and is still more preferably 12% or less, 10% or less, and 8% or less, in order of increasing preference.

SrO is a component which improves the meltability of the glass and is also a component which improves the crushability of the chemically strengthened glass, and may be contained. The content of SrO, when it is contained, is preferably 0.5% or more, more preferably 1% or more, still more preferably 2% or more, especially preferably 3% or more, most preferably 5% or more. Meanwhile, the content of SrO is preferably 20% or less because SrO contents exceeding 20% result in a considerable decrease in ion-exchange performance. The content of SrO is more preferably 16% or less and is still more preferably 12% or less, 10% or less, and 8% or less, in order of increasing preference.

BaO is a component which improves the meltability of the glass and is also a component which improves the crushability of the chemically strengthened glass, and may be contained. The content of BaO, when it is contained, is preferably 0.5% or more, more preferably 1% or more, still more preferably 2% or more, especially preferably 3% or more, most preferably 5% or more. Meanwhile, the content of BaO is preferably 20% or less because BaO contents exceeding 20% result in a considerable decrease in ion-exchange performance. The content of BaO is more preferably 16% or less and is still more preferably 12% or less, 10% or less, and 8% or less, in order of increasing preference.

ZnO is a component which improves the meltability of the glass, and may be contained. The content of ZnO, when it is contained, is preferably 0.25% or more, more preferably 0.5% or more. Meanwhile, in the case where the content of ZnO exceeds 10%, the glass has considerably reduced weatherability. The content of ZnO is preferably 10% or less and is more preferably 8% or less, 6% or less, 4% or less, 2% or less, and 1% or less, in order of increasing preference.

Na₂O is a component which improves the meltability of the glass. Although Na₂O is not essential, the content thereof, when it is contained, is preferably 1% or more, more preferably 2% or more, especially preferably 4% or more. Too many Na₂O contents result in a decrease in chemical strengthening characteristics. Hence, the content of Na₂O is preferably 15% or less, more preferably 12% or less, especially preferably 10% or less, most preferably 8% or less.

K₂O, as with Na₂O, is a component which lowers the melting temperature of the glass, and may be contained. The content of K₂O, when it is contained, is preferably 0.5% or more, more preferably 0.8% or more, still more preferably 1% or more, yet still more preferably 1.2% or more, especially preferably 1.5% or more. Too many K₂O contents result in a decrease in chemical strengthening characteristics or a decrease in chemical durability. Hence, the content of K₂O is preferably 5% or less, more preferably 4.8% or less, still more preferably 4.6% or less, especially preferably 4.2% or less, most preferably 4.0% or less.

The total content Na₂O+K₂O of Na₂O and K₂O, is preferably 3% or more, more preferably 5% or more, from the viewpoint of improving the meltability of the raw materials for the glass. In addition, in the case where with respect to the total content of Li₂O, Na₂O and K₂O (hereinafter, referred to as R₂O), a ratio K₂O/R₂O of the content of K₂O is 0.2 or less, the chemical strengthening properties can be enhanced and the chemical durability can be increased, which is preferable. K₂O/R₂O is more preferably 0.15 or less, still more preferably 0.10 or less. Incidentally, R₂O is preferably 10% or more, more preferably 12% or more, still more preferably 15% or more. Also, R₂O is preferably 20% or less, more preferably 18% or less.

ZrO₂ is a component which enhances the mechanical strength and chemical durability and significantly improves the CS, and is preferably contained. The content of ZrO₂ is preferably 0.5% or more, more preferably 0.7% or more, still more preferably 1.0% or more, especially preferably 1.2% or more, most preferably 1.5% or more. Meanwhile, from the viewpoint of inhibiting devitrification during melting, the content of ZrO₂ is preferably 8% or less, more preferably 7.5% or less, still more preferably 7% or less, especially preferably 6% or less. Too many ZrO₂ contents result in an increase in a devitrification temperature and hence in a decrease in the viscosity. From the viewpoint of inhibiting the glass from having impaired formability due to the decrease in the viscosity, the content of ZrO₂, when the glass has a low viscosity during forming, is preferably 5% or less, more preferably 4.5% or less, still more preferably 3.5% or less.

ZrO₂/R₂O is preferably 0.01 or more, more preferably 0.02 or more, still more preferably 0.04 or more, especially preferably 0.08 or more, most preferably 0.1 or more, from the viewpoint of enhancing the chemical durability. ZrO₂/R₂O is preferably 0.2 or less, more preferably 0.18 or less, still more preferably 0.16 or less, especially preferably 0.14 or less.

TiO₂ is not essential, and the content thereof, when it is contained, is preferably 0.05% or more, more preferably 0.1% or more. Meanwhile, from the viewpoint of inhibiting devitrification during melting, the content of TiO₂ is preferably 1% or less, more preferably 0.5% or less, still more preferably 0.3% or less.

SnO₂ is not essential, and the content thereof, when it is contained, is preferably 0.5% or more, more preferably 1% or more, still more preferably 1.5% or more, especially preferably 2% or more. Meanwhile, from the viewpoint of inhibiting devitrification during melting, the content of SnO₂ is preferably 4% or less, more preferably 3.5% or less, still more preferably 3% or less, especially preferably 2.5% or less.

Y₂O₃ is a component which has the effect of making the chemically strengthened glass less apt to scatter fragments when breaking, and may be contained. The content of Y₂O₃ is preferably 0.3% or more, more preferably 0.5% or more, still more preferably 0.7% or more, especially preferably 1.0% or more. Meanwhile, from the viewpoint of inhibiting devitrification during melting, the content of Y₂O₃ is preferably 5% or less, more preferably 4% or less.

B₂O₃ is a component which improves the chipping resistance of the glass for chemical strengthening or the chemically strengthened glass and improves the meltability, and may be contained. The content of B₂O₃, when it is contained, is preferably 0.5% or more, more preferably 1% or more, still more preferably 2% or more, from the viewpoint of improving the meltability. Meanwhile, too many B₂O₃ contents tend to result in the occurrence of striae or phase separation during melting and in a decrease in the quality of the glass for chemical strengthening. Hence, the content of B₂O₃ is preferably 10% or less. The content of B₂O₃ is more preferably 8% or less, still more preferably 6% or less, especially preferably 4% or less.

La₂O₃, Nb₂O₅, and Ta₂O₅ are each a component which makes the chemically strengthened glass less apt to scatter fragments when breaking, and may be contained in order to heighten the refractive index. In the case where these are contained, the total content of La₂O₃, Nb₂O₅, and Ta₂O₅ (hereinafter the total content being referred to as La₂O₃+Nb₂O₅+Ta₂O₅) is preferably 0.5% or more, more preferably 1% or more, still more preferably 1.5% or more, especially preferably 2% or more. Meanwhile, from the viewpoint of making the glass less apt to devitrify during melting, La₂O₃+Nb₂O₅+Ta₂O₅ is preferably 4% or less, more preferably 3% or less, still more preferably 2% or less, especially preferably 1% or less.

CeO₂ may be contained. CeO₂ may suppress coloration by oxidizing the glass. The content of CeO₂, when it is contained, is preferably 0.03% or more, more preferably 0.05% or more, still more preferably 0.07% or more. From the viewpoint of enhancing the transparency, the content of CeO₂ is preferably 1.5% or less, more preferably 1.0% or less.

In the case of coloring the chemically strengthened glass, a coloring component may be added thereto within a range not hindering the achievement of desired chemical strengthening properties. Example of the coloring component include Co₃O₄, MnO₂, Fe₂O₃, NiO, CuO, Cr₂O₃, V₂O₅, Bi₂O₃, SeO₂, Er₂O₃, and Nd₂O₃.

The content of the coloring component is preferably 1% or less in total. In the case of wishing to increase the visible light transmittance of the glass more, it is preferable to be substantially free of these components.

In order to increase the weather resistance against ultraviolet irradiation, HfO₂, Nb₂O₅, and Ti₂O₃ may be added thereto. In the case of adding these components thereto for the purpose of increasing the weather resistance against ultraviolet irradiation, in order to reduce the influence on other properties, the total content of HfO₂, Nb₂O₅, and Ti₂O₃ is preferably 1% or less, more preferably 0.5% or less, still more preferably 0.1% or less.

In addition, SO₃, a chloride, and a fluoride may be suitably contained as, for example, a refining agent for melting the glass. The total content of such components functioning as a refining agent is preferably 2% or less, more preferably 1% or less, still more preferably 0.5% or less, in mass % in terms of oxides since excessive addition thereof affects the strength properties. Although there is no particular lower limit, the total content thereof is typically preferably 0.05% or more in mass % in terms of oxides.

In the case of using SO₃ as a refining agent, the content of SO₃ in mass % in terms of oxides is preferably 0.01% or more, more preferably 0.05% or more, still more preferably 0.1% or more, since too small contents thereof are ineffective. The content of SO₃ in the case of using SO₃ as a refining agent is preferably 1% or less, more preferably 0.8% or less, still more preferably 0.6% or less, in mass % in terms of oxides.

In the case of using Cl as a refining agent, the content of Cl in mass % in terms of oxides is preferably 1% or less, more preferably 0.8% or less, still more preferably 0.6% or less, since excessive addition thereof affects properties including the strength properties. The content of Cl in the case of using Cl as a refining agent is preferably 0.05% or more, more preferably 0.1% or more, still more preferably 0.2% or more, in mass % in terms of oxides since too small contents thereof are ineffective.

In the case of using SnO₂ as a refining agent, the content of SnO₂ in mass % in terms of oxides is preferably 1% or less, more preferably 0.5% or less, still more preferably 0.3% or less. The content of SnO₂ in the case of using SnO₂ as a refining agent is preferably 0.02% or more, more preferably 0.05% or more, still more preferably 0.1% or more, in mass % in terms of oxides since too small contents thereof are ineffective.

P₂O₅ is preferably not contained. In the case of containing P₂O₅, the content thereof is preferably 2.0% or less, more preferably 1.0% or less, and it is most preferable not to contain P₂O₅.

As₂O₃ is preferably not contained. In the case of containing As₂O₃, the content thereof is preferably 0.3% or less, more preferably 0.1% or less, and it is most preferable not to contain As₂O₃.

<Method for Manufacturing the Chemically Strengthened Glass>

A method for manufacturing a chemically strengthened glass according to one embodiment of the present invention (hereinafter also abbreviated as this manufacturing method) is explained below.

This manufacturing method is characterized by including the following successive steps (1) to (3):
(1) subjecting a lithium-containing glass to an ion exchange at least once with a first inorganic-salt composition containing potassium;
(2) keeping the lithium-containing glass in contact with a second inorganic-salt composition including LiNO₃ and NaNO₃ and having a mass ratio of NaNO₃ to LiNO₃ of 0.25 to 3.0, at 425° C. or higher for 5 hours or longer to perform a reverse ion exchange; and
(3) subjecting the lithium-containing glass to an ion exchange at least once with a third inorganic-salt composition containing potassium.

Each of the steps is explained below.

«Step (1)»

Step (1) is a step of subjecting a lithium-containing glass to an ion exchange at least once with a first inorganic-salt composition containing potassium. The lithium-containing glass contains lithium and has a composition that can be strengthened by forming and a chemical strengthening treatment. Examples of the glass include a aluminosilicate glass, a soda-lime glass, a borosilicate glass, a lead glass, an alkali-barium glass, and an aluminoborosilicate glass.

A preferred composition of the lithium-containing glass is the same as that described in the section «Composition» under <Chemically Strengthened Glass>. That is, the lithium-containing glass preferably has a base composition including, by mole percentage in terms of oxides, 52 to 75% SiO₂, 8 to 20% Al₂O₃, and 5 to 18% Li₂O. Glasses having such preferred base composition have the property of making potassium less apt to be scattered into the glass by an ion exchange. In this manufacturing method, however, a large amount of potassium ions can be introduced into surface layers of the glass to enhance the surface strength.

The chemical strengthening treatment for forming a compressive stress layer in the surface layers of the glass is a treatment in which the glass is brought into contact with the first inorganic-salt composition to replace metal ions present in the glass by metal ions present in the first inorganic-salt composition which have a larger ionic radius than the metal ions.

Examples of the method for bringing the glass into contact with the first inorganic salt composition include a method of applying a paste-like inorganic salt composition onto the glass, a method of spraying an aqueous solution of an inorganic salt composition on the glass, and a method of immersing a glass sheet in a salt bath of a molten salt of an inorganic salt composition, heated at a temperature of the melting point or higher. Among these, from the viewpoint of enhancing the productivity, a method of immersing the glass in a molten salt of an inorganic salt composition is preferred.

The chemical strengthening treatment by the method in which the glass is immersed in a molten salt of the first inorganic-salt composition can be conducted, for example, in the following manner. First, the glass is preheated to 100° C. or higher, and the molten salt is regulated so as to have a temperature at which chemical strengthening is to be performed. Subsequently, the preheated glass is immersed in the molten salt for a given time period and the glass is then pulled out of the molten salt and allowed to cool.

The salts included in the first inorganic-salt composition for use in the ion exchange of the step (1) are not particularly limited, and examples thereof include sodium nitrate, sodium carbonate, sodium chloride, sodium borate, sodium sulfate, potassium nitrate, potassium carbonate, potassium chloride, potassium borate, potassium sulfate, lithium nitrate, lithium carbonate, lithium chloride, lithium borate, and lithium sulfate. One of these may be added thereto alone, or two or more thereof may be added thereto in combination. Examples of the first inorganic-salt composition containing potassium include an inorganic-salt composition preferably including sodium nitrate or potassium nitrate.

The temperature at which the lithium-containing glass is brought into contact with the first inorganic-salt composition in the step (1) is not particularly limited. However, from the viewpoint of heightening the rate of an ion exchange to improve the production efficiency, the temperature is preferably 310° C. or higher, more preferably 330° C. or higher, still more preferably 350° C. or higher. Meanwhile, from the viewpoint of diminishing salt vaporization, the temperature for the contact is preferably 530° C. or lower, more preferably 500° C. or lower, still more preferably 480° C. or lower.

The contact time between the lithium-containing glass and the first inorganic-salt composition in the step (1) is not particularly limited. However, from the viewpoint of reducing unevenness in ion-exchange level due to fluctuations in time period, the contact time is preferably 30 minutes or longer, more preferably 45 minutes or longer, still more preferably 1 hour or longer. From the viewpoint of improving the production efficiency, the contact time is preferably 20 hours or less.

The ion exchange of the step (1) may be either one-stage ion exchange or multistage ion exchange configured of two or more stages, so long as an ion exchange in which the lithium-containing glass is brought into contact with the first inorganic-salt composition containing potassium is conducted at least once.

Examples of the ion exchange configured of two or more stages in the step (1) include the following.

As an initial ion exchange, a glass sheet is brought into contact with an inorganic-salt composition including NaNO₃ in an amount of preferably 20 mass % or more to cause an ion exchange between Li ions contained in the glass and Na ions contained in the inorganic-salt composition. And then as the second-stage ion exchange, the glass sheet is brought into contact with an inorganic-salt composition including KNO₃ in an amount of preferably 80 mass % or more to cause an ion exchange between Na ions contained in the glass and K ions contained in the inorganic-salt composition.

The content of NaNO₃ in the inorganic-salt composition during the initial ion exchange is more preferably 30 mass % or more, still more preferably 40 mass % or more. The content of KNO₃ in the inorganic-salt composition during the second-stage ion exchange is more preferably 85 mass % or more, still more preferably 90 mass % or more.

The compressive stress layer formed in surface layers of the lithium-containing glass in the step (1) is not particularly limited in compressive stress (CS) in the outermost surface thereof. However, the compressive stress (CS) is usually preferably 600 MPa or more, more preferably 650 MPa or more, still more preferably 700 MPa or more,

«Step (2)»

Step (2) is a reverse ion exchange step in which the lithium-containing glass is brought into contact with a second inorganic-salt composition including LiNO₃ and NaNO₃ to cause an ion exchange between ions contained in the lithium-containing glass and ions having a smaller ionic radius than the ions, thereby reducing the compressive stress of the compressive stress layer formed in the step (1). More specifically, for example, K ions in the glass are replaced by Na ions contained in the second inorganic-salt composition, and Na ions in the glass are replaced by Li ions contained in the second inorganic-salt composition.

The second inorganic-salt composition to be used in the step (2) includes LiNO₃ and NaNO₃ and has a mass ratio NaNO₃/LiNO₃ of NaNO₃ to LiNO₃ of 0.25 to 3.0. Since the mass ratio NaNO₃/LiNO₃ is 0.25 to 3.0, the Na ion concentration of surface layers of the glass can be sufficiently reduced to heighten the efficiency of the reverse ion exchange. From the viewpoint of improving the efficiency of the reverse ion exchange, the mass ratio NaNO₃/LiNO₃ is more preferably 0.40 or more, still more preferably 0.55 or more, especially preferably 0.75 or more. Meanwhile, the mass ratio NaNO₃/LiNO₃ is more preferably 2.5 or less, still more preferably 1.8 or less, especially preferably 1.3 or less.

The content of LiNO₃ in the second inorganic-salt composition to be used in the step (2) is preferably 20 mass % or more, more preferably 30 mass % or more, still more preferably 40 mass % or more. Meanwhile, the content of LiNO₃ in the second inorganic-salt composition is preferably 75 mass % or less, more preferably 70 mass % or less, still more preferably 65 mass % or less.

The second inorganic-salt composition may contain other inorganic salts besides LiNO₃ and NaNO₃. Examples of the other inorganic salts include sodium carbonate, sodium chloride, sodium borate, sodium sulfate, potassium nitrate, potassium carbonate, potassium chloride, potassium borate, potassium sulfate, lithium carbonate, lithium chloride, lithium borate, and lithium sulfate.

Preferred examples among these include KNO₃, from the viewpoint that the efficiency of the reverse ion exchange can be heightened therewith without increasing the content of LiNO₃. In the case where the second inorganic-salt composition contains KNO₃, the content of KNO₃ in the second inorganic-salt composition is preferably 5 mass % or more, more preferably 10 mass % or more, still more preferably 15 mass % or more. Meanwhile, the content of KNO₃ in the second inorganic-salt composition is preferably 60 mass % or less, more preferably 50 mass % or less, still more preferably 40 mass % or less.

The temperature at which the lithium-containing glass is brought into contact with the second inorganic-salt composition in the step (2) is 425° C. or higher and is preferably 435° C. or higher, more preferably 445° C. or higher. Since the temperature for the contact is 425° C. or higher, the efficiency of the reverse ion exchange can be heightened to sufficiently withdraw ions from the glass, thereby heightening the efficiency of the re-ion exchange of the step (3) to improve the strength. In addition, the glass can be inhibited from expanding in the steps (1) and (2). Meanwhile, from the viewpoint of diminishing salt vaporization, the temperature for the contact is preferably 500° C. or lower, more preferably 485° C. or lower, still more preferably 470° C. or lower.

The contact time between the lithium-containing glass and the second inorganic-salt composition in the step (2) is preferably 4 hours or longer, more preferably 6 hours or longer, still more preferably 8 hours or longer, from the viewpoint of reducing unevenness in ion-exchange level due to fluctuations in the time period to improve the efficiency of the reverse ion exchange and from the viewpoint of inhibiting the glass from expanding in the steps (1) and (2). Meanwhile, from the viewpoint of improving the production efficiency, the contact time is preferably 72 hours or less, more preferably 48 hours or less, still more preferably 24 hours or less.

The lower the compressive stress of the compressive stress layer reduced in the step (2), the more preferred. It is most preferable that the compressive stress layer be completely removed. For example, the compressive stress (CS) of the compressive stress layer after the initial ion exchange step, at a depth of 50 μm from the surface, is preferably 10 MPa or less, more preferably 7 MPa or less, still more preferably 4 MPa or less, most preferably 0 MPa. Meanwhile, the compressive stress of the surface of the glass after the step (2) may be 100 MPa or less and is preferably 50 MPa or less, more preferably 20 MPa or less, still more preferably 10 MPa or less.

The lithium-containing glass undergone the reverse ion exchange in the step (2) has a degree of expansion, along the longitudinal direction of the glass sheet, of preferably 0.4% or less, more preferably 0.3% or less, still more preferably 0.2% or less, most preferably 0.1% or less, with respect to the lithium-containing glass before the ion exchange of the step (1). By regulating the degree of expansion to 0.4% or less, the glass can be inhibited from suffering warpage or the like due to an increased degree of expansion. There is no particular lower limit on the degree of expansion, and the closer the degree of expansion to 0, the more preferred. However, the degree of expansion thereof is usually −0.05% or more.

«Step (A)»

This manufacturing method may include the following step (A) between the reverse ion exchange step (2) and the re-ion exchange step (3): (A) removing 0.5 to 15 μm per single side of one or both surfaces of the lithium-containing glass.

The removal amount of the surface of the lithium-containing glass in the step (A), per single side, is 0.5 μm or more, preferably 0.7 μm or more, more preferably 0.9 μm or more, still more preferably 1.3 μm or more. Moreover, the removal amount in the step (A) per single side is 15 μm or less, preferably 12 μm or less, more preferably 10 μm or less, still more preferably 8 μm or less. By regulating the removal amount in the step (A) to a value within the above range, not only micro scratches (defects) in the surface of the glass are removed but also any fogging resulting from the reverse ion exchange can be sufficiently removed.

In the removal of the surfaces of the lithium-containing glass in the step (A), both surfaces need not be equal in terms of polishing amount. For example, in the case where the difference in polishing amount between both surfaces is preferably 3.0 μm or less, warpage can be reduced. The difference is more preferably 2.0 μm or less, still more preferably 1.0 μm or less, especially preferably 0.5 μm or less.

Examples of methods for removing the surface of the lithium-containing glass include polishing and etching the surface of the glass. In the step (A), it is preferred to remove the surfaces by the same amount from the two main surfaces of the glass sheet which face each other in the sheet thickness direction, from the viewpoint of preventing glass warpage. However, conditions for the removal in the step (A) are not particularly limited, and the removal may be conducted under such conditions as to result in desired surface roughness.

As a means for polishing, for example, abrasive grains such as cerium oxide and colloidal silica can be employed. The abrasive grains preferably have an average particle diameter of 0.02 to 2.0 μm, and a preferred concentration of the abrasive grains is such that slurry thereof has a specific gravity of 1.03 to 1.13. A preferred polishing pressure is 6 to 20 kPa. The rotational speed of a surface plate of a polishing device is preferably 20 to 100 m/min in terms of outermost-periphery circumferential speed. For example, a general method can be used in which cerium oxide having an average particle diameter of about 1.2 μm is dispersed in water to produce slurry having a specific gravity of 1.07 and a polishing pad having a nonwoven-fabric or suede surface is used to polish surface layers of the glass sheet in an amount of 0.5 μm or more per single side under the conditions of a polishing pressure of 9.8 kPa. In the polishing step, application can be made of polishing pads which have a nonwoven-fabric or suede surface and have a Shore A hardness of 25 to 65° and an amount of the sinking at 100 g/cm² of 0.05 mm or more. Preferred of these are polishing pads made of nonwoven fabric, from the viewpoint of cost.

Examples of removal of the surface of the glass by etching include etching with a chemical containing hydrofluoric acid.

«Step (3)»

Step (3) is a re-ion exchange step in which the lithium-containing glass reduced in compressive stress in the step (2) is brought into contact with a third inorganic-salt composition containing potassium to conduct an ion exchange at least once with the third inorganic-salt composition so that a compressive stress layer having enhanced compressive stress is formed in surface layers of the glass sheet.

Specifically, in the step (3), an ion exchange is caused between ions contained in the glass and ions having a more ionic radius than the ions to increase the compressive stress of the compressive stress layer. More specifically, for example, Na ions in the glass are replaced by K ions contained in the third inorganic-salt composition, and Li ions in the glass are replaced by Na ions contained in the third inorganic-salt composition.

Examples of the salts included in the third inorganic-salt composition for use in the ion exchange of the step (3) include sodium nitrate, sodium carbonate, sodium chloride, sodium borate, sodium sulfate, potassium nitrate, potassium carbonate, potassium chloride, potassium borate, and potassium sulfate. One of these may be used alone, or two or more thereof may be used in combination.

The kinds and contents of the salts included in the third inorganic-salt composition to be used in the ion exchange of the step (3) can be suitably set so that a desired compressive stress and a desired depth of a compressive stress layer are obtained.

For example, in a method for causing an ion exchange between Na ions in the glass and K ions in the third inorganic-salt composition, the third inorganic-salt composition to be used is one which includes KNO₃ in an amount of preferably 20 mass % or more, more preferably 30 mass % or more, still more preferably 40 mass % or more.

The ion exchange of the step (3) may be either one-stage ion exchange or multistage ion exchange configured of two or more stages, so long as an ion exchange in which the lithium-containing glass is brought into contact with the third inorganic-salt composition containing potassium is conducted at least once.

Examples of the ion exchange configured of two or more stages in the step (3) include the following.

As an initial ion exchange, a glass sheet is brought into contact with an inorganic-salt composition including NaNO₃ in an amount of preferably 20 mass % or more to cause an ion exchange between Li ions contained in the glass and Na ions contained in the inorganic-salt composition. And then as the second-stage ion exchange, the glass sheet is brought into contact with an inorganic-salt composition including KNO₃ in an amount of preferably 80 mass % or more to cause an ion exchange between Na ions contained in the glass and K ions contained in the inorganic-salt composition.

The content of NaNO₃ in the inorganic-salt composition during the initial ion exchange is more preferably 30 mass % or more, still more preferably 40 mass % or more. The content of KNO₃ in the inorganic-salt composition during the second-stage ion exchange is more preferably 85 mass % or more, still more preferably 90 mass % or more.

The temperature at which the lithium-containing glass is brought into contact with the third inorganic-salt composition in the ion exchange of the step (3) is not particularly limited. However, from the viewpoint of heightening the rate of the ion exchange to improve the production efficiency, the temperature is preferably 310° C. or higher, more preferably 330° C. or higher, still more preferably 350° C. or higher. Meanwhile, from the viewpoint of diminishing salt vaporization, the temperature is preferably 530° C. or lower, more preferably 500° C. or lower, still more preferably 480° C. or lower.

The contact time between the lithium-containing glass and the third inorganic-salt composition in the ion exchange of the step (3) is not particularly limited. However, from the viewpoint of reducing unevenness in ion-exchange level due to fluctuations in time period, the contact time is preferably 30 minutes or longer, more preferably 45 minutes or longer, still more preferably 1 hour or longer. From the viewpoint of improving the production efficiency, the contact time is preferably 20 hours or less.

In the case where the ion exchange of the step (1) and the ion exchange of the step (3) each include ion exchanges of two stages, the time period of the initial ion exchange in the ion exchange of the step (3) is preferably longer than the time period of the initial ion exchange in the ion exchange of the step (1). Thus, Na ions that are excessively withdrawn from the surface of the glass in the step (2) can be sufficiently introduced into surface layers of the glass.

This manufacturing method preferably further includes a step for cleaning the glass, between the steps. For the cleaning, use can be made of industrial water, ion-exchanged water, etc. Conditions for the cleaning vary depending on the cleaning liquid. In the case of using the ion-exchanged water, cleaning at a temperature of 0 to 100° C. is preferred because adherent salts can be completely removed thereby. Various methods can be used in the cleaning step, such as, for example, a method in which the glass is immersed in a water tank containing the ion-exchanged water, etc., a method in which the surface of the glass is exposed to running water, and a method in which a cleaning liquid is jetted to the surface of the glass with a shower.

The compressive stress layer of the chemically strengthened glass produced by this manufacturing method is not particularly limited in its compressive stress (CS). However, at a depth of 50 μm from the surface, the compressive stress (CS) is preferably 50 MPa or more, more preferably 60 MPa or more, still more preferably 70 MPa or more. The surface compressive stress of the chemically strengthened glass produced by this manufacturing method is not particularly limited, but the surface compressive stress may be 500 MPa or more and is preferably 600 MPa or more, more preferably 700 MPa or more, still more preferably 800 MPa or more.

### EXAMPLES

Hereinafter, the present invention is described in accordance with Examples, but the invention is not limited thereto.

<Production of Chemically Strengthened Glasses>

Raw materials for the glass were mixed together so as to result in the following composition shown by mole percentage in terms of oxides, and some of the mixture was weighed out in an amount of 400 g in terms of glass amount. Subsequently, the raw-material mixture was put in a platinum crucible, and introduced into an electric furnace of 1,500 to 1,700° C. to melt for about 3 hours, defoam, and homogenize the contents.

Glass material A: 69.2% of SiO₂, 12.4% of Al₂O₃, 0.1% of MgO, 0.1% of CaO, 0.3% of ZrO₂, 1.3% of Y₂O₃, 10.6% of Li₂O, 4.7% of Na₂O, 1.2% of K₂O

The molten glass obtained was poured into a metal die, held for 1 hour at a temperature higher by about 50° C. than the glass transition point, and then cooled to room temperature at a rate of 0.5° C./min, thereby obtaining a glass block. Glass sheets having dimensions of 50 mm×50 mm×0.7 mm were produced from the obtained glass block.

Step (1): Ion Exchange Step

The glass sheets obtained above were immersed in inorganic-salt compositions under the conditions shown in Table 1 to conduct ion exchange treatments. In the case indicated by “Initial stage” and “Second stage” in Table 1, an initial-stage ion exchange treatment was followed by a second-stage ion exchange treatment. Between the ion exchange treatments, the surfaces of each glass sheet were cleaned and dried.

Step (2): Reverse Ion Exchange Step

After the ion exchange step, the glass sheets were immersed in inorganic-salt compositions under the conditions shown in Table 1 to conduct ion exchange treatments, thereby performing reverse ion exchange. Thereafter, the surfaces of each glass sheet were cleaned and dried.

Step (A): Removal Step

As a polishing slurry, a slurry having a specific gravity of 1.07 was produced by dispersing cerium oxide having an average particle diameter (d50) of 1.2 μm in water. Next, the obtained slurry was used to simultaneously polish both surfaces of each glass sheet in an amount of 5 μm each with a nonwoven-fabric polishing pad having a Shore A hardness of 58° and an amount of the sinking at 100 g/cm² of 0.11 mm, under the conditions of a polishing pressure of 9.8 kPa.

Step (3): Re-Ion Exchange Step

After the removal step, the glass sheets were immersed in inorganic-salt compositions under the conditions shown in Table 1 to conduct ion exchange treatments, thereby performing re-ion exchange. Thereafter, the surfaces of each glass sheet were cleaned and dried.

<Evaluation>

Various evaluations in the present Examples were conducted by the methods shown below.

### (EPMA)

Each glass was examined for K₂O concentration or Na₂O concentration with an EPMA in the following manner. First, a glass sample was embedded in an epoxy resin, and the embedded sample was mechanically polished along a plane perpendicular to a first main surface and a second main surface facing the first main surface, thereby producing a cross-section sample. The cross-section obtained by the polishing was subjected to C coating and examined with an EPMA (JXA-8500F, manufactured by JEOL Ltd.). An X-ray intensity line profile of K₂O or Na₂O was acquired at intervals of 1 μm under the conditions of an accelerating voltage of 15 kV, a probe current of 30 nA, and an integrated time of 1,000 msec./point. With respect to the K₂O concentration profile and Na₂O concentration profiles obtained, an average count for [center in a thickness direction (0.5×t)]±25 μm (sheet thickness being taken as t μm) was regarded as a bulk composition and counts for the whole sheet thickness were proportionally converted to mol % to calculate K₂O or Na₂O concentrations. Thus, slopes (%/μm) in the respective regions shown in Table 2 were obtained.

(Stress Profile)

The chemically strengthened glasses were examined for stress using a scattered light photoelastic stress meter (SLP-2000, manufactured by Orihara Industrial Co., Ltd.) by the method described in WO 2018/056121. Furthermore, stress profiles were calculated using the software [SlpV (Ver. 2019.11.07.001)] attached to the scattered light photoelastic stress meter (SLP-2000, manufactured by Orihara Industrial Co., Ltd.).

The function used for obtaining the stress profiles was σ(x)=[a₁×erfc(a₂×x)+a₃×erfc(a₄×x)+a₅], where aᵢ (i=1 to 5) is a fitting parameter and erfc is a complementary error function. The complementary error function is defined by the following equation.

$$\begin{matrix}erfc ( x ) = 1 - erf ( x ) \\ = \frac{2}{\sqrt{π}} {\int }_{x}^{∞} {e}^{- {t}^{2}} dt = {e}^{- {x}^{2}} erfcx ( x )\end{matrix}$$

In the evaluation of the present specification, the residual sum of squares between the obtained raw data and the above-described function was minimized to optimize the fitting parameters. Individual items were set by designation or selection in the following manner: measurement processing condition was obtained by single shot; measurement region processing adjustment item was an edge method in the surface; internal surface edge was 6.0 μm; internal left-right edge was automatic; internal deep portion edge was automatic (center of sample film thickness); and elongation of a phase curve to the center of a sample thickness was a fitting curve.

Stress in a surface layer portion of each glass at dozens of micrometers or more from a surface of the glass was measured using a glass surface stress meter (FSM 6000-UV, manufactured by Orihara Industrial Co., Ltd.) by the method described in WO 2018/056121 and WO 2017/115811.

At the same time, a concentration distribution of alkali metal ions (sodium ions and potassium ions) in a sectional direction was measured with by SEM-EDX (EPMA) and confirmed to be consistent with the obtained stress profile.

In addition, from the obtained stress profile, the values of compressive stress CS₀, DOL, CS₅₀, CS₉₀, CTave, CT-Max, and DOC were calculated by the methods described above.

(Depth of Potassium-Ion Diffusion Layer)

The depth of a potassium-ion diffusion layer was a depth at which the K₂O concentration comes into the range of +2σ or less, with respect to an average K₂O concentration (%) in [center in a thickness direction (0.5×t)]±25 μm and a dispersion σ thereof in the K₂O concentration profile obtained by the EPMA in a view from the outermost-surface side.

(Degree of Expansion)

The change of the longitudinal-direction length of each glass sheet which had undergone the re-ion exchange of the step (3) from the longitudinal-direction length of the glass sheet which had not undergone the ion exchange of the step (1) was measured as the degree of expansion. The lengths of the glass sheet were measured with a digital caliper manufactured by Mitsutoyo Corp.

(4PB Strength)

Each glass for chemical strengthening was cut into 50 mm×50 mm and subjected to automatic chamfering (C-chamfering) with a No. 1,000 grinding stone (manufactured by Tokyo Diamond Tools Mfg. Co., Ltd.) to obtain glass sheets of 50×50×0.7 (thickness) mm. The glass sheets were treated by the steps (1), (2), (A), and (3) in this order and then subjected to a four-point bending test under the conditions of a distance between outer fulcrums of 30 mm in a supporting tool, a distance between inner fulcrums of 10 mm therein, and a crosshead speed of 5.0 mm/min to measure a four-point bending strength. The number of test pieces was 10.

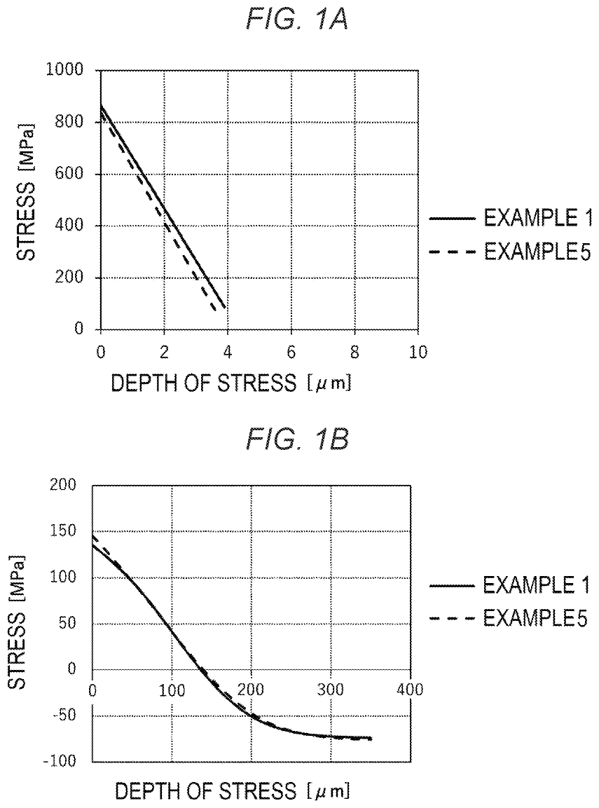

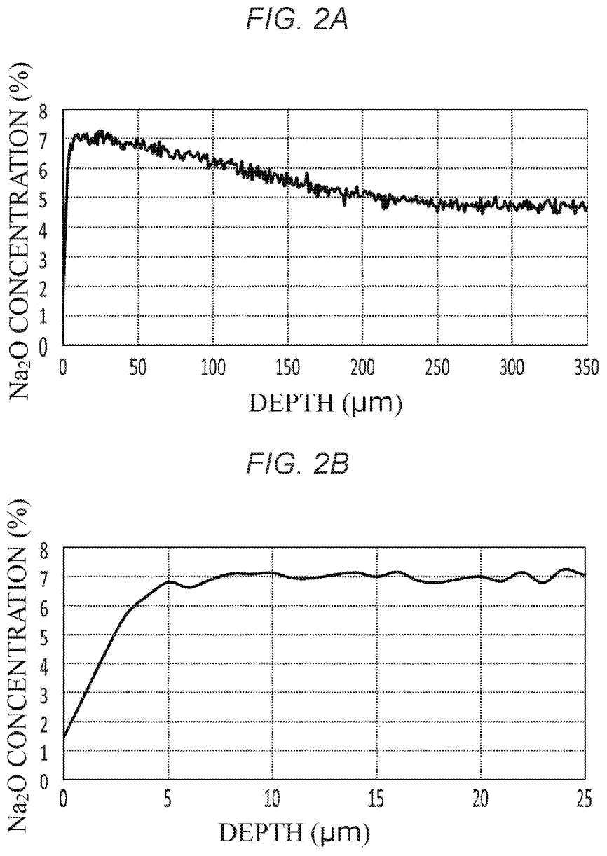

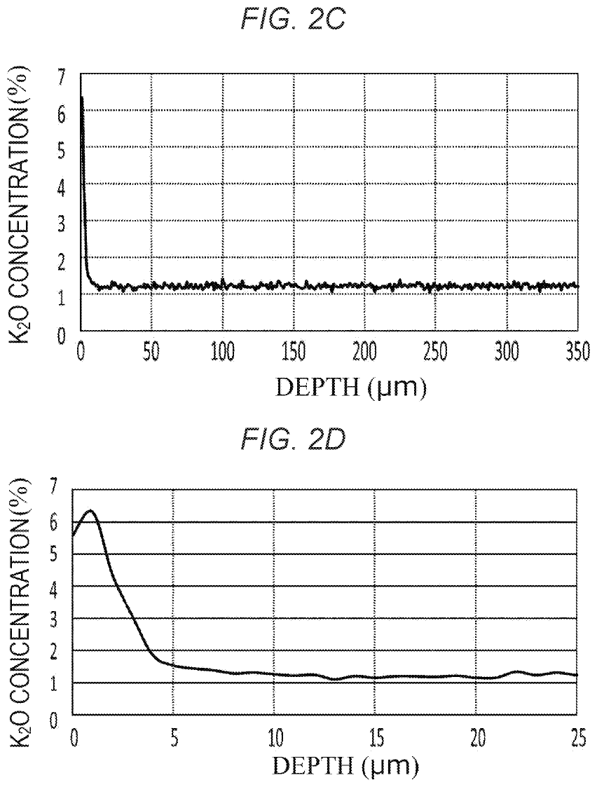

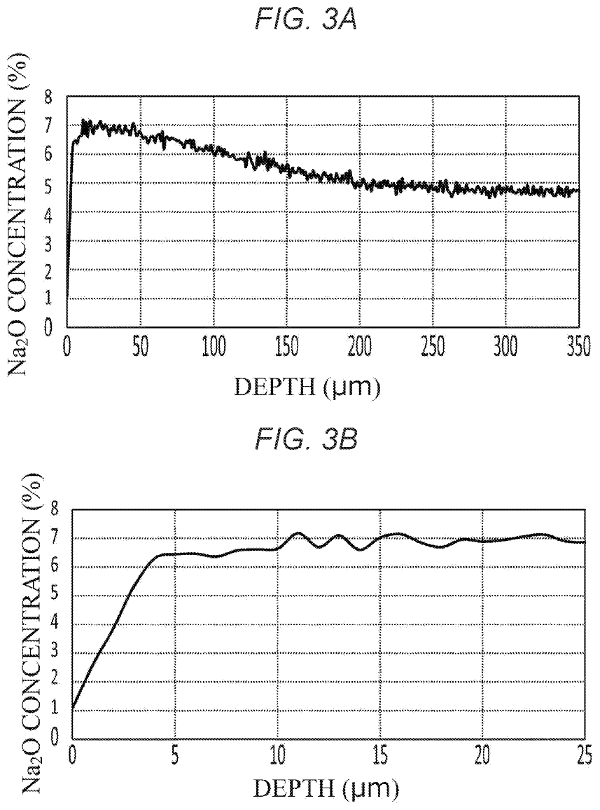

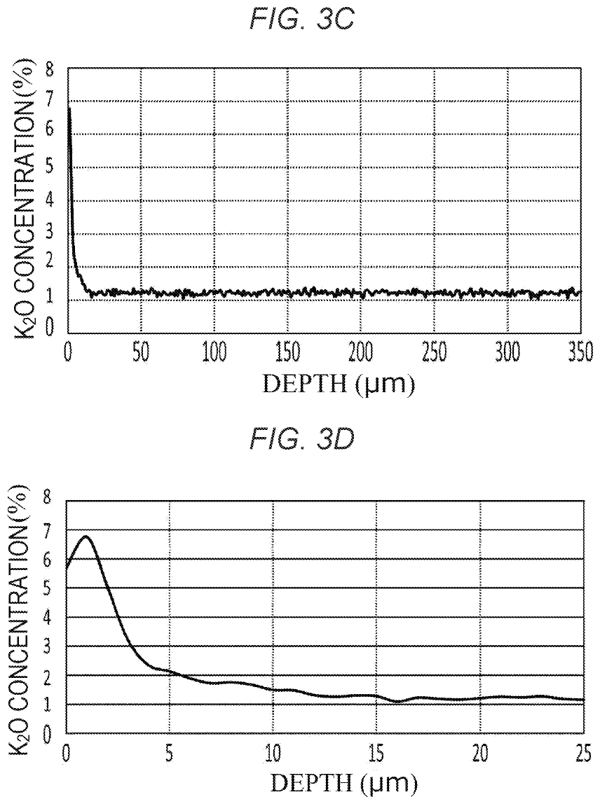

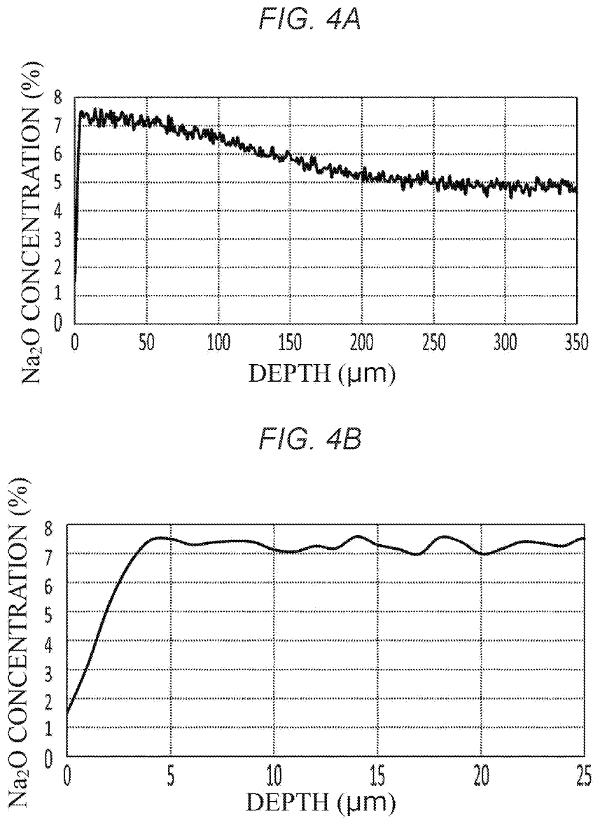

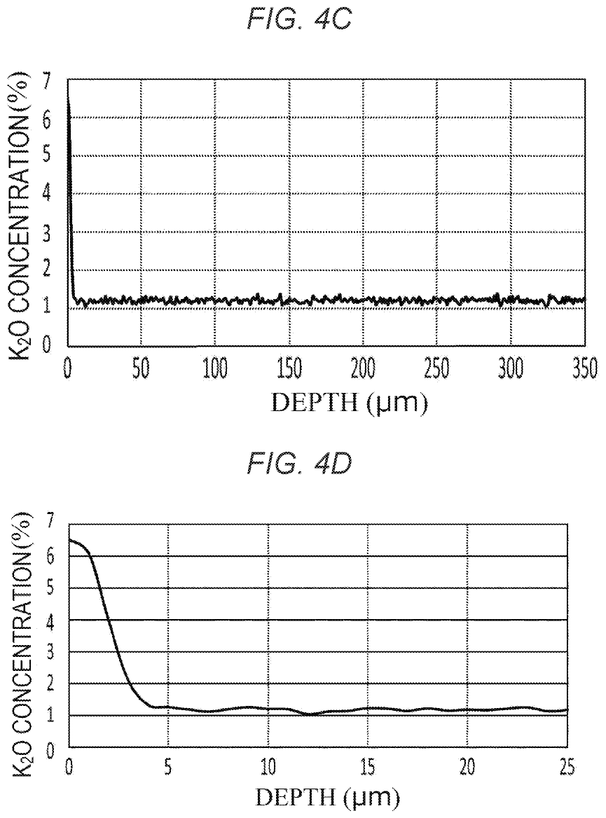

The results of the evaluation of the chemically strengthened glasses are shown in Table 2. In Tables 1 and 2, Examples 1 to 4 are Inventive Examples, and Example 5 is Comparative Example. The stress profiles of Examples 1 and 5 are shown in FIG. 1. The K₂O concentration or Na₂O concentration profiles of Examples 1, 2, and 5 are shown in FIG. 2 to FIG. 4, respectively.

The following expressions given in Table 2 have the meanings shown below. “N.D.” indicates that the property was not determined.

t [μm]: Sheet thickness

CS₀ [MPa]: Compressive stress at surface of the glass

DOL (may be referred to also as DOL-tail) [μm]: Depth of a compressive stress layer measured using the FSM (curve approximation)

CS₅₀ [MPa]: Compressive stress a depth of 50 μm from surface of the glass

CS₉₀ [MPa]: Compressive stress a depth of 90 μm from surface of the glass

CTave [MPa]: Average value of tensile stress

CT-Max (MPa): Maximum tensile stress

DOC [μm]: Depth of a compressive stress measured using the SLP-2000

mK1-3 [mol %/μm]: Slope at a depth of 1 to 3 μm in K₂O concentration profile

mK5-10 [mol %/μm]: Slope at a depth of 5 to 10 μm in K₂O concentration profile

mNa10-50 [mol %/μm]: Slope at a depth of 10 to 50 μm in Na₂O concentration profile

mNa50-90 [mol %/μm]: Slope at a depth of 50 to 90 μm in Na₂O concentration profile

|mK5-10/mK1-3|: Absolute value of value obtained by dividing slope at a depth of 5 to 10 μm in K₂O concentration profile by slope at a depth of 1 to 3 μm therein

|mNa50-90/mNa10-50|: Absolute value of value obtained by dividing slope at a depth of 50 to 90 μm in Na₂O concentration profile by slope at a depth of 10 to 50 μm therein

Absolute value of difference in K₂O concentration between a depth of 15 to 25 μm and center portion: Absolute value of difference between K₂O concentration (%) at a depth of 15 to 25 μm and K₂O concentration (%) in center portion

4PB strength: Average value of results of four-point bending strength measurement on 10 test pieces

TABLE 1

| | | | Example 1 | | Example 2 | | Example 3 | | Example 4 | | Example 5 | |
|---|---|---|---|---|---|---|---|---|---|---|---|---|
| Ion | Initial | Inorganic-salt | NaNO₃ 100% | | NaNO₃ 100% | | NaNO₃ 100% | | NaNO₃ 100% | | NaNO₃ 100% | |
| exchange | stage | composition | | | | | | | | | | |
| step | | (mass %) | | | | | | | | | | |
| | | Temperature | 420° C. | | 420° C. | | 420° C. | | 420° C. | | 420° C. | |
| | | Time period | 90 | min | 90 | min | 90 | min | 90 | min | 90 | min |
| | Second | Inorganic-salt | KNO₃ 99.6% + | | KNO₃ 99.6% + | | KNO₃ 99.6% + | | KNO₃ 99.6% + | | KNO₃ 99.6% + | |
| | stage | composition | LiNO₃ 0.4% | | LiNO₃ 0.4% | | LiNO₃ 0.4% | | LiNO₃ 0.4% | | LiNO₃ 0.4% | |
| | | (mass %) | | | | | | | | | | |
| | | Temperature | 400° C. | | 400° C. | | 400° C. | | 400° C. | | 400° C. | |
| | | Time period | 100 | min | 100 | min | 100 | min | 100 | min | 100 | min |

| Reverse | Inorganic-salt composition | | NaNO₃ 50% + | | NaNO₃ 50% + | | NaNO₃ 50% + | | NaNO₃ 70% + | | not conducted |
|---|---|---|---|---|---|---|---|---|---|---|---|
| ion | (mass %) | | LiNO₃ 50% | | LiNO₃ 50% | | LiNO₃ 50% | | LiNO₃ 30% | | |
| exchange | NaNO₃/LiNO₃ (mass ratio) in | | 1 | | 1 | | 1 | | 2.3 | | |
| step | inorganic-salt composition | | | | | | | | | | |
| | Temperature | | 450° C. | | 450° C. | | 450° C. | | 450° C. | | |
| | Time period | | 600 | min | 600 | min | 600 | min | 720 | min | |
| Removal | Surface removal amount | | 5 | μm/side | 1 | μm/side | 5 | μm/side | 5 | μm/side | not conducted |
| step | | | | | | | | | | | |
| Re-ion | Initial | Inorganic-salt | NaNO₃ 100% | | NaNO₃ 100% | | NaNO₃ 100% | | NaNO₃ 100% | | not conducted |
| exchange | stage | composition | | | | | | | | | |
| step | | (mass %) | | | | | | | | | |
| | | Temperature | 420° C. | | 420° C. | | 420° C. | | 420° C. | | |
| | | Time period | 105 | min | 105 | min | 90 | min | 90 | min | |
| | Second | Inorganic-salt | KNO₃ 99.6% + | | KNO₃ 99.6% + | | KNO₃ 99.6% + | | KNO₃ 99.6% + | | not conducted |
| | stage | composition | LiNO₃ 0.4% | | LiNO₃ 0.4% | | LiNO₃ 0.4% | | LiNO₃ 0.4% | | |
| | | (mass %) | | | | | | | | | |
| | | Temperature | 400° C. | | 400° C. | | 400° C. | | 400° C. | | |
| | | Time period | 100 | min | 100 | min | 100 | min | 100 | min | |

TABLE 2

| | Example 1 | Example 2 | Example 3 | Example 4 | Example 5 |
|---|---|---|---|---|---|
| t [μm] | 700 | 700 | 700 | 700 | 700 |
| CS₀ [MPa] | 865 | 830 | 865 | 822 | 837 |
| DOL [μm] | 3.9 | 4.5 | 4.1 | 4.0 | 3.6 |
| CS₅₀ [MPa] | 96 | 94 | 86 | 81 | 96 |
| CS₉₀ [MPa] | 53 | 51 | 44 | 46 | 53 |
| CTave [MPa] | 56 | 57 | 54 | 50 | 56 |
| CT-Max [MPa] | 73 | 77 | 71 | 70 | 75 |
| DOC [μm] | 137 | 133 | 129 | 145 | 140 |
| Reverse strengthening | conducted | conducted | conducted | conducted | not |
| | | | | | conducted |
| Polishing amount [μm/side] | 5 | 1 | 5 | 5 | nil |
| Re-strengthening | conducted | conducted | conducted | conducted | not |
| | | | | | conducted |
| Depth of K diffusion [μm] | 8 | 12 | 7 | 9 | 4 |
| mK1-3 [mol %/μm] | −1.596 | −1.733 | −1.583 | −1.661 | −1.960 |
| mK5-10 [mol %/μm] | −0.052 | −0.107 | −0.086 | −0.043 | 0.001 |
| mNa10-50 [mol %/μm] | −0.007 | −0.004 | −0.004 | −0.003 | −0.003 |
| mNa50-90 [mol %/μm] | −0.010 | −0.009 | −0.012 | −0.006 | −0.013 |
| \|mK5-10/mK1-3\| | 0.032 | 0.062 | 0.054 | 0.026 | 0.000 |
| \|mNa50-90/mNa10-50\| | 1.356 | 2.541 | 3.286 | 2.544 | 4.145 |
| Absolute value of difference | 0.014 | 0.020 | 0.024 | 0.027 | 0.030 |
| in K₂O concentration between | | | | | |
| a depth of 15-25 μm and | | | | | |
| center portion [%] | | | | | |
| Degree of expansion [%] | 0.09% | 0.09% | 0.09% | 0.14% | 0.08% |
| 4PB strength [MPa] | 576 | N.D. | N.D. | N.D. | 464 |

As Table 2 shows, Example 1 that is Inventive Example showed an excellent 4PB strength as compared with Example 5 that is Comparative Example. As Table 2 and FIG. 1A show, Examples 1 and 2 that are Inventive Examples contained a large amount of K ions introduced into surface layers, as compared with Example 5 that is Comparative Example, to have high stress in the surface layer portions and show excellent strength. Example 3 that is Inventive Example contained a large amount of K ions introduced into surface layers, as compared with Comparative Example, to have a high surface compressive stress CS₀ and show excellent strength. Example 4 that is Inventive Example contained a large amount of K ions introduced into surface layers, as compared with Comparative Example, to have a large depth of compressive stress DOC and show excellent strength.

Example 1 that is Inventive Example was higher in CS₅₀ and DOC than Example 3 that is Inventive Example. It seems from the results that making the time period of the initial ion exchange of the step (3) longer than the time period of the initial ion exchange of the step (1) can heighten the CS₅₀ and DOC to further improve the falling strength.

Example 3 that is Inventive Example had a lower degree of glass expansion than Example 4 that is Inventive Example. It seems from the results that in the case where the NaNO₃/LiNO₃ ratio in the step (2) is lower, the degree of expansion during the period up to the step (2) can be reduced and, hence, the degree of expansion after the step (3) can be lower.

Furthermore, a glass (glass material B) differing in composition from the glass (glass material A) used in the Examples given above was prepared, and this glass was used to produce glasses for chemical strengthening. Raw materials for glass were mixed together so as to result in the composition of the following glass material B shown by mole percentage in terms of oxides, and some of the mixture was weighed out in an amount of 400 g in terms of glass amount. Subsequently, the raw-material mixture was put in a platinum crucible, and introduced into an electric furnace of 1,500 to 1,700° C. to melt for about 3 hours, defoam, and homogenize the contents.

Glass material B: 66.2% of SiO₂, 11.2% of Al₂O₃, 3.1% of MgO, 0.2% of CaO, 1.3% of ZrO₂, 0.5% of Y₂O₃, 10.4% of Li₂O, 5.6% of Na₂O, 1.5% of K₂O

The molten glass obtained was poured into a metal die, held for 1 hour at a temperature higher by about 50° C. than the glass transition point, and then cooled to room temperature at a rate of 0.5° C./min, thereby obtaining a glass block. Glass sheets having dimensions of 50 mm×50 mm×0.6 mm were produced from the obtained glass block.

Thereafter, the step (1) as ion exchange step, the step (2) as reverse ion exchange step, the step (A) as removal step, and the step (3) as re-ion exchange step were conducted under the conditions shown in Table 3 to produce chemically strengthened glasses.

Various properties of the chemically strengthened glasses obtained by chemically strengthening the glasses of glass material B were evaluated by the same methods as for the chemically strengthened glasses obtained by chemically strengthening the glasses of glass material A.

The results of the evaluation of the chemically strengthened glasses obtained by chemically strengthening the glasses of glass material B are shown in Table 4. In Tables 3 and 4, Examples 6 to 9 are Inventive Examples, and Example 10 is Comparative Example.

TABLE 3

| | | | Example 6 | | Example 7 | | Example 8 | | Example 9 | | Example 10 | |
|---|---|---|---|---|---|---|---|---|---|---|---|---|
| Ion | Initial | Inorganic-salt | KNO₃ 60% + | | KNO₃ 60% + | | KNO₃ 60% + | | KNO₃ 60% + | | KNO₃ 60% + | |
| exchange | stage | composition | NaNO₃ 40% | | NaNO₃ 40% | | NaNO₃ 40% | | NaNO₃ 40% | | NaNO₃ 40% | |
| step | | (mass %) | | | | | | | | | | |
| | | Temperature | 410° C. | | 410° C. | | 410° C. | | 410° C. | | 410° C. | |
| | | Time period | 180 | min | 180 | min | 180 | min | 180 | min | 180 | min |
| | Second | Inorganic-salt | KNO₃ 99.3% + | | KNO₃ 99.3% + | | KNO₃ 99.3% + | | KNO₃ 99.3% + | | KNO₃ 99.3% + | |
| | stage | composition | NaNO₃ 0.6% + | | NaNO₃ 0.6% + | | NaNO₃ 0.6% + | | NaNO₃ 0.6% + | | NaNO₃ 0.6% + | |
| | | (mass %) | LiNO₃ 0.1% | | LiNO₃ 0.1% | | LiNO₃ 0.1% | | LiNO₃ 0.1% | | LiNO₃ 0.1% | |
| | | Temperature | 390° C. | | 390° C. | | 390° C. | | 390° C. | | 390° C. | |
| | | Time period | 60 | min | 60 | min | 60 | min | 60 | min | 60 | min |

| Reverse | Inorganic-salt composition | KNO₃ 20% + | | KNO₃ 20% + | | NaNO₃ 70% + | | NaNO₃ 70% + | | NaNO₃ 70% + | |
|---|---|---|---|---|---|---|---|---|---|---|---|
| ion | (mass %) | NaNO₃ 48% + | | NaNO₃ 48% + | | LiNO₃ 30% | | LiNO₃ 30% | | LiNO₃ 30% | |
| exchange | | LiNO₃ 32% | | LiNO₃ 32% | | | | | | | |
| step | NaNO₃/LiNO₃ (mass ratio) in | 1.5 | | 1.5 | | 2.3 | | 2.3 | | 2.3 | |
| | inorganic-salt composition | | | | | | | | | | |
| | Temperature | 450° C. | | 450° C. | | 450° C. | | 450° C. | | 450° C. | |
| | Time period | 300 | min | 300 | min | 720 | min | 720 | min | 720 | min |

| Removal | Surface removal amount | | 5 | μm/side | 5 | μm/side | 5 | μm/side | 5 | μm/side | — |
|---|---|---|---|---|---|---|---|---|---|---|---|
| step | | | | | | | | | | | |
| Re-ion | Initial | Inorganic-salt | KNO₃ 60% + | | KNO₃ 60% + | | KNO₃ 60% + | | KNO₃ 60% + | | |
| exchange | stage | composition | NaNO₃ 40% | | NaNO₃ 40% | | NaNO₃ 40% | | NaNO₃ 40% | | |
| step | | (mass %) | | | | | | | | | |
| | | Temperature | 410° C. | | 410° C. | | 410° C. | | 410° C. | | — |
| | | Time period | 180 | min | 210 | min | 180 | min | 210 | min | — |
| | Second | Inorganic-salt | KNO₃ 99.3% + | | KNO₃ 99.3% + | | KNO₃ 99.3% + | | KNO₃ 99.3% + | | — |
| | stage | composition | NaNO₃ 0.6% + | | NaNO₃ 0.6% + | | NaNO₃ 0.6% + | | NaNO₃ 0.6% + | | |
| | | (mass %) | LiNO₃ 0.1% | | LiNO₃ 0.1% | | LiNO₃ 0.1% | | LiNO₃ 0.1% | | |
| | | Temperature | 390° C. | | 390° C. | | 390° C. | | 90° C. | | — |
| | | Time period | 60 | min | 60 | min | 60 | min | 60 | min | — |

TABLE 4

| | Example 6 | Example 7 | Example 8 | Example 9 | Example 10 |
|---|---|---|---|---|---|
| t [μm] | 600 | 600 | 600 | 600 | 600 |
| CS₀ [MPa] | 915 | 902 | 925 | 898 | unmeasurable |
| DOL [μm] | 3.8 | 3.9 | 3.4 | 3.8 | unmeasurable |
| CS₅₀ [MPa] | 94 | 99 | 101 | 101 | −8 |
| CS₉₀ [MPa] | 16 | 16 | 19 | 21 | −3 |
| CTave [MPa] | 62 | 65 | 63 | 67 | 5 |
| CT-Max [MPa] | 81 | 90 | 86 | 92 | 9 |
| DOC [μm] | 100 | 100 | 100 | 104 | 174 |
| Reverse strengthening | conducted | conducted | conducted | not | conducted |
| | | | | conducted | |
| Polishing amount [μm/side] | 5 [μm/side] | 5 [μm/side] | 5 [μm/side] | 5 [μm/side] | nil |
| Re-strengthening | conducted | conducted | conducted | conducted | not |
| | | | | | conducted |
| Depth of K diffusion [μm] | 7 | 7 | 7 | 9 | 9 |
| mK1-3 [mol %/μm] | −1.688 | −1.636 | −1.468 | −1.579 | 0.045 |
| mK5-10 [mol %/μm] | −0.059 | −0.067 | −0.094 | −0.07 | −0.049 |
| mNa10-50 [mol %/μm] | −0.024 | −0.021 | −0.028 | −0.022 | 0.001 |
| mNa50-90 [mol %/μm] | −0.023 | −0.024 | −0.021 | −0.024 | 0 |
| \|mK5-10/mK1-3\| | 0.035 | 0.041 | 0.064 | 0.044 | 1.08 |
| \|mNa50-90/mNa10-50\| | 0.951 | 1.126 | 0.743 | 1.104 | 0.321 |
| Absolute value of difference | 0.037 | 0.021 | 0.049 | 0.017 | 0.013 |
| in K₂O concentration between | | | | | |
| a depth of 15-25 μm and | | | | | |
| center portion [%] | | | | | |
| Degree of expansion | 0.11% | 0.12% | 0.10% | 0.11% | 0.00% |

As shown in Table 4, Examples 6 to 9 that are Inventive Examples each had a slope mK1-3 [mol %/μm] of −1.9 or more at a depth of 1 to 3 μm and a slope mK5-10 [mol %/μm] of −0.001 or less at a depth of 5 to 10 μm, like Examples 1 to 4 that are Inventive Examples.

Examples 6 to 9 that are Inventive Examples were further examined as follows.

Examples 6 to 9 that are Inventive Examples, like Examples 1 to 4 that are Inventive Examples, satisfied that the absolute value, |mK5-10/mK1-3|, of a value obtained by dividing the slope (%/μm) at a depth of 5 to 10 μm by the slope (%/μm) at a depth of 1 to 3 μm was 0.005 to 0.10.

Examples 6 to 9 that are Inventive Examples, like Examples 1 to 4 that are Inventive Examples, satisfied that the absolute value, |mNa50-90/mNa10-50|, of a value obtained by dividing the slope (%/μm) at a depth of 50 to 90 μm by the slope (%/μm) at a depth of 10 to 50 μm was 0.50 to 4.0.

Examples 6 to 9 that are Inventive Examples, like Examples 1 to 4 that are Inventive Examples, satisfied that the absolute value of the difference between the K₂O concentration (%) at a depth of 15 to 25 μm and the K₂O concentration (%) at the center in a thickness direction was 0.20% or less.

Examples 6 to 9 that are Inventive Examples each had a potassium-ion diffusion layer depth of 5 μm or more, like Examples 1 to 4 that are Inventive Examples

Examples 6 to 9 that are Inventive Examples had a large value of the slope mK1-3 [mol %/μm] at a depth of 1 to 3 μm and a small value of the slope mK5-10 [mol %/μm] at a depth of 5 to 10 μm, as compared with Example 5, which is Comparative Example in which the reverse ion exchange step had not been conducted.

It was seen that Examples 6 to 9 that are Inventive Examples contained a large amount of K ions introduced into the portion at a depth of 15 to 25 μm to have high stress in the surface layer portions and show excellent strength, as compared with Example 10, which is Comparative Example in which the re-ion exchange step had not been conducted.

As described above, this specification discloses the following matters.
1. A chemically strengthened glass, having a slope of a K₂O concentration of −1.9%/μm or more at a depth of 1 to 3 μm and −0.001%/μm or less at a depth of 5 to 10 μm, in a K₂O concentration profile having an abscissa representing the depth (μm) from a surface of the glass and an ordinate representing the K₂O concentration (%) by mole percentage in terms of oxides.
2. The chemically strengthened glass according to claim 1, having a slope of a Na₂O concentration of −0.001%/μm or less at a depth of 10 to 50 μm and −0.012%/μm or more at a depth of 50 to 90 μm, in a Na₂O concentration profile having an abscissa representing the depth (μm) from a surface of the glass and an ordinate representing the Na₂O concentration (%) by mole percentage in terms of oxides.
3. The chemically strengthened glass according to the item 1 or 2, having an absolute value of a value obtained by dividing the slope (%/μm) of the K₂O concentration at the depth of 5 to 10 μm by the slope (%/μm) of the K₂O concentration at the depth of 1 to 3 μm of 0.005 or more and 0.10 or less.
4. The chemically strengthened glass according to any one of the items 1 to 3, having an absolute value of a value obtained by dividing a slope (%/μm) of a Na₂O concentration at a depth of 50 to 90 μm by a slope (%/μm) of a Na₂O concentration at a depth of 10 to 50 μm of 0.50 or more and 4.0 or less, in a Na₂O concentration profile having an abscissa representing the depth (μm) from the surface of the glass and an ordinate representing the Na₂O concentration (%) by mole percentage in terms of oxides.
5. The chemically strengthened glass according to any one of the items 1 to 4, having an absolute value of a difference between a K₂O concentration (%) at a depth of 15 to 25 μm and a K₂O concentration (%) in a center in a thickness direction of 0.20% or less, in the K₂O concentration profile.
6. The chemically strengthened glass according to any one of the items 1 to 5, including a potassium-ion diffusion layer having a depth of 5 μm or more.
7. The chemically strengthened glass according to any one of the items 1 to 6, being a lithium-containing glass.
8. The chemically strengthened glass according to any one of the items 1 to 7, having a base composition including, by mole percentage in terms of oxides,
   52 to 75% of SiO₂,
   8 to 20% of Al₂O₃, and
   5 to 18% of Li₂O.
9. The chemically strengthened glass according to any one of the items 1 to 8, having a base composition including, by mole percentage in terms of oxides,
   52 to 75% of SiO₂,
   8 to 20% of Al₂O₃,
   5 to 18% of Li₂O,
   0 to 15% of Na₂O,
   0 to 5% of K₂O,
   0 to 20% of MgO,
   0 to 20% of CaO,
   0 to 20% of SrO,
   0 to 20% of BaO,
   0 to 10% of ZnO,
   0 to 1% of TiO₂,
   0 to 8% of ZrO₂, and
   0 to 5% of Y₂O₃.
10. A method for manufacturing a chemically strengthened glass, including the following successive steps (1) to (3):
   (1) subjecting a lithium-containing glass to an ion exchange at least once with a first inorganic-salt composition containing potassium;
   (2) keeping the lithium-containing glass in contact with a second inorganic-salt composition including LiNO₃ and NaNO₃ and having a mass ratio of NaNO₃ to LiNO₃ of 0.25 to 3.0, at 425° C. or higher for 5 hours or longer to perform a reverse ion exchange; and
   (3) subjecting the lithium-containing glass to an ion exchange at least once with a third inorganic-salt composition containing potassium.
11. The method for manufacturing a chemically strengthened glass according to the item 10, in which the lithium-containing glass includes, by mole percentage in terms of oxides,
   52 to 75% of SiO₂,
   8 to 20% of Al₂O₃, and
   5 to 18% of Li₂O.
12. The method for manufacturing a chemically strengthened glass according to the item 10 or 11, in which the lithium-containing glass includes, by mole percentage in terms of oxides,
   52 to 75% of SiO₂,
   8 to 20% of Al₂O₃,
   5 to 18% of Li₂O,
   0 to 15% of Na₂O,
   0 to 5% of K₂O,
   0 to 20% of MgO,
   0 to 20% of CaO,
   0 to 20% of SrO,
   0 to 20% of BaO,
   0 to 10% of ZnO,
   0 to 1% of TiO₂,
   0 to 8% of ZrO₂, and
   0 to 5% of Y₂O₃.
13. The method for manufacturing a chemically strengthened glass according to any one of the items 10 to 12, in which the ion exchange of the step (1) and the ion exchange of the step (3) each include ion exchanges of two stages, and
   an initial ion exchange in the ion exchange of the step (3) is conducted for a longer period than an initial ion exchange in the ion exchange of the step (1).
14. The method for manufacturing a chemically strengthened glass according to any one of the items 10 to 13, further including the following step (A) between the steps (2) and (3):
   (A) removing 0.5 to 15 μm per single side of one or both surfaces of the lithium-containing glass.
15. The method for manufacturing a chemically strengthened glass according to the item 14, in which in the step (A), the lithium-containing glass is polished to have a difference in polishing amount between the both surfaces of 3.0 μm or less.
16. A chemically strengthened glass, having a slope of a K₂O concentration of −1.9%/μm or more and 0.0%/μm or less at a depth of 1 to 3 μm and −0.001%/μm or less at a depth of 5 to 10 μm, in a K₂O concentration profile having an abscissa representing the depth (μm) from a surface of the glass and an ordinate representing the K₂O concentration (%) by mole percentage in terms of oxides.
17. The chemically strengthened glass according to the item 16, in which the slope of the K₂O concentration at the depth of 1 to 3 μm is −1.9%/μm or more and −1.000%/μm or less.
18. The chemically strengthened glass according to the item 16, in which the slope of the K₂O concentration at the depth of 5 to 10 μm is −0.200%/μm or more and −0.001%/μm or less.

What is claimed is:

1. A chemically strengthened glass, having a slope of a K₂O concentration of −1.9%/μm or more at a depth of 1 to 3 μm and −0.001%/μm or less at a depth of 5 to 10 μm, in a K₂O concentration profile having an abscissa representing the depth (μm) from a surface of the glass and an ordinate representing the K₂O concentration (%) by mole percentage in terms of oxides.

2. The chemically strengthened glass according to claim 1, having a slope of a Na₂O concentration of −0.001%/μm or less at a depth of 10 to 50 μm and −0.012%/μm or more at a depth of 50 to 90 μm, in a Na₂O concentration profile having an abscissa representing the depth (μm) from a surface of the glass and an ordinate representing the Na₂O concentration (%) by mole percentage in terms of oxides.

3. The chemically strengthened glass according to claim 1, having an absolute value of a value obtained by dividing the slope (%/μm) of the K₂O concentration at the depth of 5 to 10 μm by the slope (%/μm) of the K₂O concentration at the depth of 1 to 3 μm of 0.005 or more and 0.10 or less.

4. The chemically strengthened glass according to claim 1, having an absolute value of a value obtained by dividing a slope (%/μm) of a Na₂O concentration at a depth of 50 to 90 μm by a slope (%/μm) of a Na₂O concentration at a depth of 10 to 50 μm of 0.50 or more and 4.0 or less, in a Na₂O concentration profile having an abscissa representing the depth (μm) from the surface of the glass and an ordinate representing the Na₂O concentration (%) by mole percentage in terms of oxides.

5. The chemically strengthened glass according to claim 1, having an absolute value of a difference between a K₂O concentration (%) at a depth of 15 to 25 μm and a K₂O concentration (%) in a center in a thickness direction of 0.20% or less, in the K₂O concentration profile.

6. The chemically strengthened glass according to claim 1, comprising a potassium-ion diffusion layer having a depth of 5 μm or more.

7. The chemically strengthened glass according to claim 1, being a lithium-containing glass.

8. The chemically strengthened glass according to claim 1, having a base composition comprising, by mole percentage in terms of oxides,
52 to 75% of SiO₂,
8 to 20% of Al₂O₃, and
5 to 18% of Li₂O.

9. The chemically strengthened glass according to claim 1, having a base composition comprising, by mole percentage in terms of oxides,
52 to 75% of SiO₂,
8 to 20% of Al₂O₃,
5 to 18% of Li₂O,
0 to 15% of Na₂O,
0 to 5% of K₂O,
0 to 20% of MgO,
0 to 20% of CaO,
0 to 20% of SrO,
0 to 20% of BaO,
0 to 10% of ZnO,
0 to 1% of TiO₂,
0 to 8% of ZrO₂, and
0 to 5% of Y₂O₃.

10. A method for manufacturing a chemically strengthened glass, comprising the following successive steps (1) to (3):
(1) subjecting a lithium-containing glass to an ion exchange at least once with a first inorganic-salt composition containing potassium;
(2) keeping the lithium-containing glass in contact with a second inorganic-salt composition including LiNO₃ and NaNO₃ and having a mass ratio of NaNO₃ to LiNO₃ of 0.25 to 3.0, at 425° C. or higher for 5 hours or longer to perform a reverse ion exchange; and
(3) subjecting the lithium-containing glass to an ion exchange at least once with a third inorganic-salt composition containing potassium.

11. The method for manufacturing a chemically strengthened glass according to claim 10, wherein the lithium-containing glass comprises, by mole percentage in terms of oxides,
52 to 75% of SiO₂,
8 to 20% of Al₂O₃, and
5 to 18% of Li₂O.

12. The method for manufacturing a chemically strengthened glass according to claim 10, wherein the lithium-containing glass comprises, by mole percentage in terms of oxides,
52 to 75% of SiO₂,
8 to 20% of Al₂O₃,
5 to 18% of Li₂O,
0 to 15% of Na₂O,
0 to 5% of K₂O,
0 to 20% of MgO,
0 to 20% of CaO,
0 to 20% of SrO,
0 to 20% of BaO,
0 to 10% of ZnO,
0 to 1% of TiO₂,
0 to 8% of ZrO₂, and
0 to 5% of Y₂O₃.

13. The method for manufacturing a chemically strengthened glass according to claim 10, wherein the ion exchange of the step (1) and the ion exchange of the step (3) each comprise ion exchanges of two stages, and
an initial ion exchange in the ion exchange of the step (3) is conducted for a longer period than an initial ion exchange in the ion exchange of the step (1).

14. The method for manufacturing a chemically strengthened glass according to claim 10, further comprising the following step (A) between the steps (2) and (3):
(A) removing 0.5 to 15 μm per single side of one or both surfaces of the lithium-containing glass.

15. The method for manufacturing a chemically strengthened glass according to claim 14, wherein in the step (A), the lithium-containing glass is polished to have a difference in polishing amount between the both surfaces of 3.0 μm or less.

16. A chemically strengthened glass, having a slope of a K₂O concentration of −1.9%/μm or more and 0.0%/μm or less at a depth of 1 to 3 μm and −0.001%/μm or less at a depth of 5 to 10 μm, in a K₂O concentration profile having an abscissa representing the depth (μm) from a surface of the glass and an ordinate representing the K₂O concentration (%) by mole percentage in terms of oxides.

17. The chemically strengthened glass according to claim 16, wherein the slope of the K₂O concentration at the depth of 1 to 3 μm is −1.9%/μm or more and −1.000%/μm or less.

18. The chemically strengthened glass according to claim 16, wherein the slope of the K₂O concentration at the depth of 5 to 10 μm is −0.200%/μm or more and −0.001%/μm or less.
